(19) United States
(12) Patent Application Publication
(10) Pub. No.: US 2015/0102239 A1
(43) Pub. Date: Apr. 16, 2015

(54) EXTREME ULTRAVIOLET LIGHT GENERATION SYSTEM

(71) Applicant: GIGAPHOTON INC., Tochigi (JP)

(72) Inventors: Tatsuya YANAGIDA, Tochigi (JP); Hakaru MIZOGUCHI, Tochigi (JP); Osamu WAKABAYASHI, Tochigi (JP)

(21) Appl. No.: 14/578,141

(22) Filed: Dec. 19, 2014

Related U.S. Application Data
(63) Continuation of application No. PCT/JP2013/064249, filed on May 22, 2013.

(30) Foreign Application Priority Data
Jun. 22, 2012 (JP) 2012-141079

(51) Int. Cl. H05G 2/00

(52) U.S. Cl. CPC H05G 2/008
USPC 250/504 R

(57) ABSTRACT

The extreme ultraviolet light generation system may be configured to irradiate a target with a first pulse laser beam and a second pulse laser beam to turn the target into plasma thereby generating extreme ultraviolet light. The system may include a chamber having at least one aperture configured to introduce the first pulse laser beam and the second pulse laser beam; a target supply device configured to supply the target to a predetermined region in the chamber; a first laser apparatus configured to output the first pulse laser beam with which the target in the chamber is to be irradiated, the first pulse laser beam having pulse duration less than 1 ns; and a second laser apparatus configured to output the second pulse laser beam with which the target which has been irradiated with the first pulse laser beam is to be further irradiated.

### CROSS-REFERENCE TO RELATED APPLICATIONS

This application is a Continuation Application of PCT/JP2013/064249 filed May 22, 2013, which claims priority from Japanese Patent Application No. 2012-141079 filed Jun. 22, 2012. The subject matter of each is incorporated by reference herein in entirety.

### TECHNICAL FIELD

The present disclosure relates to an extreme ultraviolet light generation system.

### BACKGROUND ART

In recent years, as semiconductor processes become finer, transfer patterns for use in photolithographies of semiconductor processes have rapidly become finer. In the next generation, microfabrication at 70 nm to 45 nm, further, microfabrication at 32 nm or less would be demanded. In order to meet the demand for microfabrication at 32 nm or less, for example, it is expected to develop an exposure apparatus in which a system for generating EUV light at a wavelength of approximately 13 nm is combined with a reduced projection reflective optical system.

Three types of EUV light generation systems have been proposed, which include an LPP (laser produced plasma) type system using plasma generated by irradiating a target with a laser beam, a DPP (discharge produced plasma) type system using plasma generated by electric discharge, and an SR (synchrotron radiation) type system using orbital radiation.

### SUMMARY

An extreme ultraviolet light generation system according to one aspect of the present disclosure may be configured to irradiate a target with a first pulse laser beam and a second pulse laser beam to turn the target into plasma thereby generating extreme ultraviolet light. The system may include a chamber having at least one aperture configured to introduce the first pulse laser beam and the second pulse laser beam; a target supply device configured to supply the target to a predetermined region in the chamber; a first laser apparatus configured to output the first pulse laser beam with which the target in the chamber is to be irradiated, the first pulse laser beam having pulse duration less than 1 ns; and a second laser apparatus configured to output the second pulse laser beam with which the target which has been irradiated with the first pulse laser beam is to be further irradiated.

### BRIEF DESCRIPTION OF THE DRAWINGS

Hereinafter, selected embodiments of the present disclosure will be described with reference to the accompanying drawings by way of example.

FIG. 1 schematically illustrates a configuration example of an LPP type EUV light generation system.

FIG. 2 is a partial cross-sectional view schematically showing a configuration example of the EUV light generation system according to a first embodiment.

FIG. 3 is a graph showing a relationship between an irradiation condition of the pre-pulse laser beam and CE in the EUV light generation system.

FIG. 4A is a graph showing a relationship between fluence of the pre-pulse laser beam and CE in the EUV light generation system. FIG. 4B is a graph showing a relationship between light intensity of the pre-pulse laser beam and the CE in the EUV light generation system.

FIGS. 5A and 5B show photographs of a diffused target after the droplet target is irradiated with the pre-pulse laser beam in the EUV light generation system.

FIG. 6 schematically illustrates an arrangement of equipment used to capture the photographs shown in FIGS. 5A and 5B.

FIGS. 7A and 7B are sectional views schematically illustrating the diffused targets respectively shown in FIGS. 5A and 5B.

FIGS. 8A through 8C are sectional views schematically illustrating a process through which a diffused target is generated when a target is irradiated with a pre-pulse laser beam having pulse duration in the picosecond range.

FIGS. 9A through 9C are sectional views schematically illustrating a process through which a diffused target is generated when a target is irradiated with a pre-pulse laser beam having pulse duration in the nanosecond range.

FIG. 10 schematically illustrates a configuration example of the pre-pulse laser apparatus shown in FIG. 2.

FIG. 11 schematically illustrates a configuration example of the mode-locked laser device shown in FIG. 10.

FIG. 12 schematically illustrates a configuration example of the regenerative amplifier shown in FIG. 10.

FIG. 13 schematically illustrates a beam path in the regenerative amplifier shown in FIG. 12 when voltage is applied to the Pockels cell.

FIGS. 14A through 14E are timing charts of various signals in the pre-pulse laser apparatus shown in FIG. 10.

FIG. 15 schematically illustrates an exemplary configuration of the main pulse laser apparatus shown in FIG. 2.

FIG. 16 is a partial sectional view schematically illustrating an exemplary configuration of an EUV light generation system according to a second embodiment.

FIG. 17 schematically illustrates an exemplary configuration of a delay time control device shown in FIG. 16.

FIG. 18 is a flowchart showing an exemplary operation of a controller shown in FIG. 17.

### EMBODIMENTS

### <Contents>

### 1. Overview

2. Description of terms
3. Overview of the EUV light generation system

3.1 Configuration

3.2 Operation

4. Extreme ultraviolet light generation system including a pre-pulse laser apparatus

4.1 Configuration

4.2 Operation

5. Parameters of the pre-pulse laser beam

5.1 Relationship between pulse duration and CE

5.2 Relationship between pulse duration and one of fluence and intensity

5.3 Relationship between pulse duration and status of diffused target

5.4 Generation process of the diffused target

5.5 Range of the pulse duration

5.6 Range of the fluence

6. Pre-pulse laser apparatus

6.1 General configuration

6.2 Mode-locked laser device

6.3 Regenerative amplifier
6.3.1 When voltage is not applied to the Pockels cell
6.3.2 When voltage is applied to the Pockels cell

6.4 Timing control

6.5 Examples of laser medium

7. Main pulse laser apparatus
8. An EUV light generation system including a device to control the second delay time

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Corresponding elements may be referenced by corresponding reference numerals and characters, and duplicate descriptions thereof may be omitted.

### 1. Overview

In an LPP type EUV light generation apparatus, a droplet target may be outputted into a chamber, and a pulse laser beam outputted from a laser system may be focused on the droplet target, whereby the target material in the droplet target may be turned into plasma. Rays of light including EUV light may be emitted from the plasma. The emitted EUV light may be collected by an EUV collector mirror disposed within the chamber and may be outputted to exposure apparatus or the like.

In the LPP type EUV light generation apparatus, the droplet target may be diffused by being irradiated with a pre-pulse laser beam, thereby forming a diffused target, and then, the diffused target may be irradiated with a main pulse laser beam. By irradiating the diffused target with the main pulse laser beam, the target material can be turned into plasma efficiently. According to this, conversion efficiency (CE) from energy of the pulse laser beam to energy of the EUV light can be improved.

In one aspect of the present disclosure, each pulse of the pre-pulse laser beam for forming the diffused target may have short pulse duration less than 1 ns, preferably less than 500 ps, more preferably less than 50 ps. Each pulse of the pre-pulse laser beam may have fluence less than fluence of the main pulse laser beam and equal to or more than 6.5 J/cm², preferably equal to or more than 30 J/cm², more preferably equal to or more than 45 J/cm².

According to this configuration, by using the pre-pulse laser beam having the short pulse duration, the target may be broken into fine particles and may be diffused. By irradiating the diffused target with the main pulse laser beam, the target may be turned into plasma efficiently and the CE may be improved.

### 2. Description of Terms

“Pulse laser beam” may refer to a laser beam including a plurality of pulses.

“Laser beam” may generally refer to a laser beam not being limited to the pulse laser beam.

“Target material” may refer to a substance, such as tin, gadolinium, terbium and the like, that may be turned into plasma by being irradiated with the pulse laser beam to emit EUV light from the plasma.

“Target” may refer to a mass, containing a minutely small amount of the target material, which is supplied into the chamber by the target supply device and irradiated with the pulse laser beam. In particular, the term “droplet target” may refer to a target containing a minutely small amount of molten target material which has been released within the chamber to be a substantially spherical shape by the surface tension of the target material.

“Diffused target” may refer to a target diffused by irradiation with the pre-pulse laser beam. The diffused target may include small particles. The diffused target may also include plasma. In comparison with the droplet target, the diffused target may have higher light absorptance. By irradiating the diffused target with the main pulse laser beam, the target material may be efficiently turned into plasma.

### 3. Overview of the EUV Light Generation System

3.1 Configuration

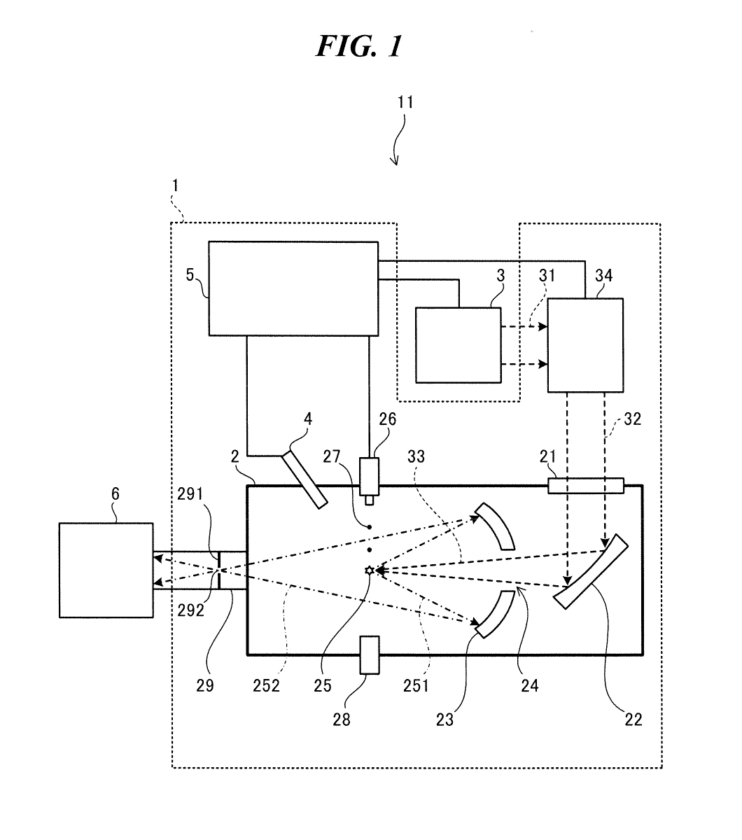

FIG. 1 schematically illustrates a configuration example of an LPP type EUV light generation system 11. An EUV light generation apparatus 1 may be used with at least one laser system 3. Hereinafter, a system that includes the EUV light generation apparatus 1 and the laser system 3 may be referred to as an EUV light generation system 11. As shown in FIG. 1 and described in detail below, the EUV light generation apparatus 1 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or a combination of any two or more of them.

The chamber 2 may have at least one through-hole in its wall. A window 21 may be located at the through-hole. A pulse laser beam 32 may travel through the window 21. In the chamber 2, an EUV collector mirror 23 having a spheroidal reflective surface may be provided. The EUV collector mirror 23 may have a first focusing point and a second focusing point. The reflective surface of the EUV collector mirror 23 may have a multi-layered reflective film in which molybdenum layers and silicon layers are alternately laminated. The EUV collector mirror 23 may be arranged such that the first focusing point is positioned in a plasma generation region 25 and the second focusing point is positioned in an intermediate focus (IF) region 292. The EUV collector mirror 23 may have a through-hole 24 formed at the center thereof so that a pulse laser beam 33 may travel through the through-hole 24.

The EUV light generation apparatus 1 may further include an EUV light generation controller 5 and a target sensor 4. The target sensor 4 may have an imaging function and detect at least one of the presence, trajectory, position and speed of a target 27.

Further, the EUV light generation apparatus 1 may include a connection part 29 for allowing the interior of the chamber 2 to be in communication with the interior of the exposure apparatus 6. In the connection part 29, a wall 291 having an aperture may be provided. The wall 291 may be positioned such that the second focusing point of the EUV collector mirror 23 lies in the aperture formed in the wall 291.

The EUV light generation apparatus 1 may also include a laser beam direction control unit 34, a laser beam focusing mirror 22, and a target collector 28 for collecting the target 27. The laser beam direction control unit 34 may include an optical element (not separately shown) for defining the direction of the pulse laser beam and an actuator (not separately shown) for adjusting the position or the posture of the optical element.

3.2 Operation

With continued reference to FIG. 1, a pulse laser beam 31 outputted from the laser system 3 may pass through the laser beam direction control unit 34 and be outputted therefrom as the pulse laser beam 32 to travel through the window 21 and enter into the chamber 2. The pulse laser beam 32 may travel inside the chamber 2 along at least one beam path, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 may be emitted from the plasma. At least EUV light included in the light 251 may be reflected selectively by the EUV collector mirror 23. The EUV light 252 reflected by the EUV collector mirror 23 may travel through the intermediate focus region 292 and be outputted to the exposure apparatus 6. Alternatively, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted; and the direction to which the target 27 is outputted. Furthermore, the EUV light generation controller 5 may be configured to control at least one of: the timing when the laser system 3 oscillates; the direction in which the pulse laser beam 33 travels; and the position at which the pulse laser beam 33 is focused. The various controls mentioned above are merely examples, and other controls may be added as necessary.

### 4. Extreme Ultraviolet Light Generation System Including a Pre-Pulse Laser Apparatus

4.1 Configuration

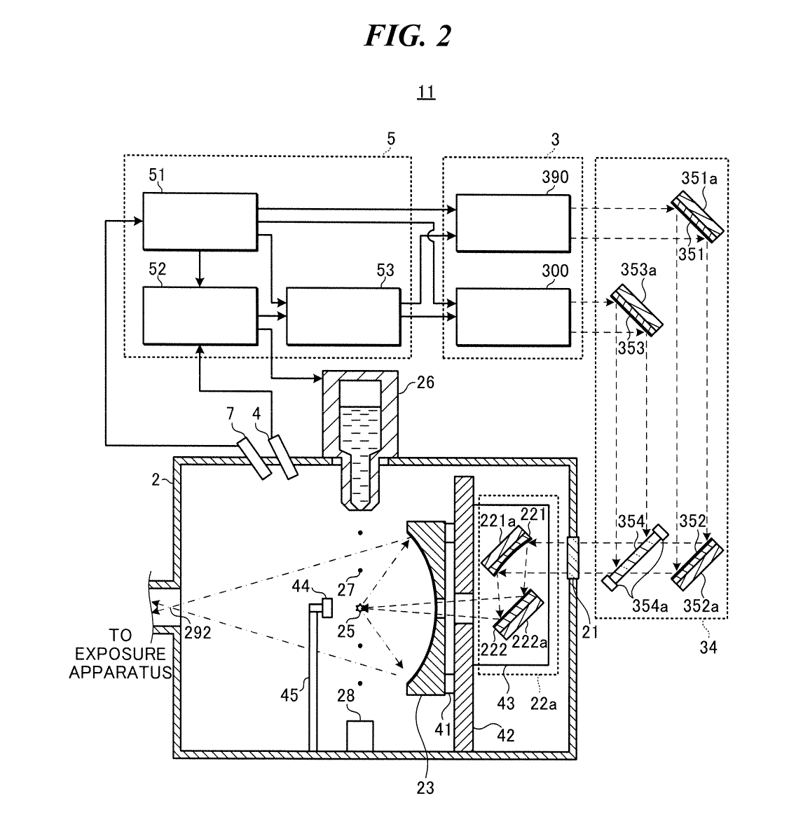

FIG. 2 is a partial cross-sectional view schematically showing a configuration example of the EUV light generation system 11 according to a first embodiment. As shown in FIG. 2, a laser beam focusing optics 22a, the EUV collector mirror 23, a target collector 28, an EUV collector mirror holder 41, plates 42 and 43, a beam dump 44, and beam dump support member 45 may be provided inside the chamber 2.

The plate 42 may be fixed to the chamber 2, and the plate 43 may be fixed to the plate 42. The EUV collector mirror 23 may be fixed to the plate 42 via the EUV collector mirror holder 41.

The laser beam focusing optics 22a may include an off-axis paraboloidal mirror 221, a flat mirror 222, and holders 221a and 222a respectively holding these mirrors. The off-axis paraboloidal mirror 221 and the flat mirror 222 may be fixed via the respective holders to the plate 43 so that the pulse laser beam reflected by these mirrors is focused on the plasma generation region 25.

The beam dump 44 may be fixed via the beam dump support member 45 to the chamber 2 so that the beam dump 44 is positioned on the extension line of the optical path of the pulse laser beam. The target collector 28 may be disposed on the extension line of the trajectory of the target 27.

The target sensor 4, the EUV light sensor 7, the window 21, and the target supply device 26 may be attached to the chamber 2. The laser beam direction control unit 34 and the EUV light generation controller 5 may be arranged outside the chamber 2.

The EUV light sensor 7 may detect light intensity of the EUV light generated in the plasma generation region 25 and output a detection signal to an EUV controller. The target supply device 26 may be a device which continues to output targets at regular intervals. Alternatively, the target supply device 26 may be a device which outputs each target on demand at timing corresponding to a trigger signal received from a target controller 52. The laser beam direction control unit 34 may include high reflection mirrors 351, 352 and 353, a dichroic mirror 354, and holders 351a, 352a, 353a and 354a respectively holding these mirrors.

The EUV light generation controller 5 may include the EUV controller 51, the target controller 52 and a delay circuit 53. The EUV controller 51 may output a control signal to the target controller 52, the delay circuit 53 and the laser system 3.

The laser system 3 may include a pre-pulse laser apparatus 300 for outputting the pre-pulse laser beam, and a main pulse laser apparatus 390 for outputting the main pulse laser beam. The dichroic mirror 354 mentioned above may have a coating to reflect wavelength components contained in the pre-pulse laser beam at high reflectance, and to transmit wavelength components contained in the main pulse laser beam at high transmittance, so that the dichroic mirror 354 functions as a beam combiner.

4.2 Operation

The target controller 52 may output a target supply start signal to the target supply device 26 so that the target supply device 26 starts supplying the target 27 to the plasma generation region 25 in the chamber 2.

The target supply device 26 may output the droplet target 27 to the plasma generation region 25 in response to receiving the target supply start signal from the target controller 52. The target controller 52 may receive a target detection signal from the target sensor 4 and output the target detection signal to the delay circuit 53. The target sensor 4 may detect timing when the target 27 passes through a predetermined position before reaching the plasma generation region 25. For example, the target sensor 4 may include an illumination device and an optical sensor (not shown). The illumination device may be a laser apparatus that may be arranged so as to output a CW laser beam toward the predetermined position. When the target 27 reaches the predetermined position, the target 27 may reflect the CW laser beam. The optical sensor may be positioned to detect reflected light reflected by the target 27. If the target passed through the predetermined position, the optical sensor may detect passage timing of the target 27 by detecting the reflected light reflected by the target 27, and output a target detection signal.

The delay circuit 53 may output a timing signal which represents timing at which a predetermined delay time has passed from the timing of the target detection signal. The delay circuit 53 may output a first timing signal to the pre-pulse laser apparatus 300 so that the pre-pulse laser beam reaches the plasma generation region 25 at the timing when the target 27 reaches the plasma generation region 25. The first timing signal may represent timing at which a first delay time has passed from the timing of the target detection signal. The delay circuit 53 may output a second timing signal to the main pulse laser apparatus 390 so that the main pulse laser beam reaches the plasma generation region 25 at timing when the target irradiated with the pre-pulse laser beam is diffused to a predetermined diffusion diameter. A delay time from the timing of outputting the first timing signal to the timing of outputting the second timing signal may be referred to as a second delay time.

The pre-pulse laser apparatus 300 may output the pre-pulse laser beam in response to the first timing signal from the delay circuit 53. The main pulse laser apparatus 390 may output the main pulse laser beam in response to the second timing signal from the delay circuit 53.

The pre-pulse laser beam outputted from the pre-pulse laser apparatus 300 may be reflected by the high reflection mirror 353 and the dichroic mirror 354, and through the window 21, enter into the laser beam focusing optics 22a. The main pulse laser beam outputted from the main pulse laser apparatus 390 may be reflected by the high reflection mirrors 351 and 352, transmitted through the dichroic mirror 354, and through the window 21, enter into the laser beam focusing optics 22a.

The pre-pulse laser beam and the main pulse laser beam entered into the laser beam focusing optics 22a may be reflected by the off-axis paraboloidal mirror 221 and the flat mirror 222, and be directed to the plasma generation region 25. The target 27 irradiated with the pre-pulse laser beam may be diffused to become a diffused target. The diffused target may be irradiated with the main pulse laser beam to be turned into plasma.

### 5. Parameters of the Pre-Pulse Laser Beam

5.1 Relationship Between Pulse Duration and CE

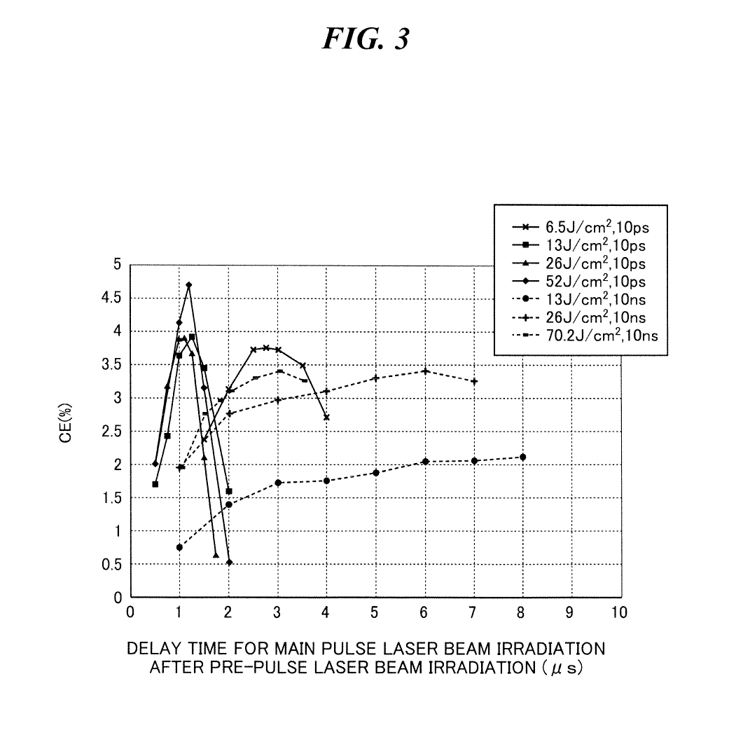

FIG. 3 is a graph showing a relationship between an irradiation condition of the pre-pulse laser beam and CE in the EUV light generation system 11. In FIG. 3, a delay time (μs) for the main pulse laser beam from the pre-pulse laser beam is plotted along the horizontal axis, and the CE (%) from energy of the main pulse laser beam into energy of the EUV light is plotted along the vertical axis. The delay time for the main pulse laser beam from the pre-pulse laser beam may be referred to as a third delay time. The third delay time may depend on the second delay time which denotes the delay time from the timing of outputting the first timing signal to the timing of outputting the second timing signal as mentioned above. However, a time period required from an input of the timing signal to the laser device to an irradiation of the target with the laser beam may depend on laser systems. Considering the above, an optimal value for the third delay time may be set. The second delay time may be controlled so that the third delay time may be close to the optimal value. The optimal value for the third delay time may be obtained by measuring time period for the target irradiated with the pre-pulse laser beam to be diffused to a predetermined diffused diameter. In FIG. 3, seven combination patterns of pulse duration defined by full width at half maximum and fluence as a measure of energy density of the pre-pulse laser beam were set, and a measurement was carried out on each combination pattern. Obtained results are shown in a line graph. Here, the fluence may be a value in which energy of the pulse laser beam is divided by area of the focusing spot. The area of the focusing spot may be area of a portion having light intensity equal to or higher than 1/e² of the peak intensity at the focusing spot.

Details of the measurement conditions are as follows. Tin (Sn) was used as the target material, and tin was molten to generate a droplet target having a diameter of 21 μm. As the pre-pulse laser apparatus, an Nd:YAG laser apparatus was used to generate a pre-pulse laser beam having a pulse duration of 10 ns. The wavelength of this pre-pulse laser beam was 1.06 μm and the pulse energy was 0.5 mJ to 2.7 mJ. To generate a pre-pulse laser beam having a pulse duration of 10 ps, a mode-locked laser device including an Nd:YVO₄ crystal was used as the master oscillator, and another laser device including an Nd:YAG crystal was used as the regenerative amplifier. The wavelength of this pre-pulse laser beam was 1.06 μm and the pulse energy thereof was 0.25 mJ to 2 mJ. The focusing spot diameter of each of the pre-pulse laser beams was 70 μm. As the main pulse laser apparatus, a CO₂ laser apparatus was used to generate a main pulse laser beam. The wavelength of the main pulse laser beam was 10.6 μm and the pulse energy thereof was 135 mJ to 170 mJ. The pulse duration of the main pulse laser beam was 15 ns, and the focusing spot diameter thereof was 300 μm.

The measurement results were as follows. As shown in FIG. 3, in the cases where the pulse duration of the pre-pulse laser beam was 10 ns, the CE did not reach 3.5% at the maximum. Further, in the cases where the pulse duration of the pre-pulse laser beam was 10 ns, the CE reached the maximum in each combination pattern when the third delay time was equal to or greater than 3 μs.

In other cases where the pulse duration of the pre-pulse laser beam was 10 ps, the maximum value of the CE in each combination pattern exceeded 3.5%. These maximum values were obtained when the third delay time was smaller than 3 μs. In particular, a CE of 4.7% was achieved in a situation where: the pulse duration of the pre-pulse laser beam was 10 ps; the fluence was 52 J/cm²; and the third delay time was 1.2 μs.

The above-described results reveal that higher CE may be achieved in the cases where the pulse duration of the pre-pulse laser beam is in a picosecond range (e.g., 10 ps) rather than in the cases where the pulse duration thereof is in a nanosecond range (e.g., 10 ns). Further, an optimal third delay time to obtain the highest CE was smaller in the cases where the pulse duration of the pre-pulse laser beam was in the picosecond range compared to the cases where the pulse duration thereof was in the nanosecond range. Accordingly, to generate EUV light at higher repetition rate, it is preferable that the pulse duration of the pre-pulse laser beam is in the picosecond range rather than in the nanosecond range.

Further, based on the results shown in FIG. 3, when the pulse duration of the pre-pulse laser beam is in the picosecond range and the fluence is 13 J/cm² to 52 J/cm², the third delay time may preferably be set as follows:

0.5 μs or more, and 1.8 μs or less;

more preferably, 0.7 μs or more, and 1.6 μs or less; or

still more preferably, 1.0 μs or more, and 1.4 μs or less.

5.2 Relationship Between Pulse Duration and One of Fluence and Intensity

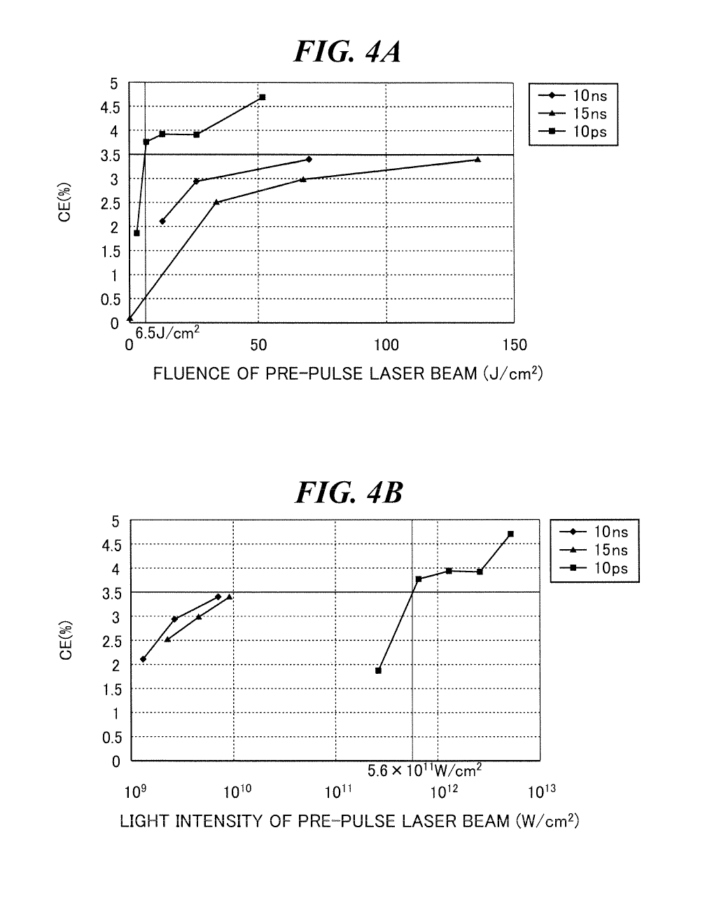

FIG. 4A is a graph showing a relationship between fluence of the pre-pulse laser beam and CE in the EUV light generation system 11. In FIG. 4A, the fluence (J/cm²) of a pre-pulse laser beam is plotted along the horizontal axis, and the CE (%) is plotted along the vertical axis. In each of the cases where the pulse duration of the pre-pulse laser beam was set to 10 ps, 10 ns, and 15 ns, the CE was measured for various third delay times, and the CE at the optimal third delay time was plotted. Here, the results shown in FIG. 3 were used to fill a part of the data where the pulse duration was 10 ps or 10 ns. Further, in order to generate a pre-pulse laser beam having a pulse duration of 15 ns, a pre-pulse laser apparatus configured similarly to the one used to generate the pre-pulse laser beam having a pulse duration of 10 ns was used.

In all of the cases where the pulse duration of the pre-pulse laser beam was 10 ps, 10 ns, and 15 ns, the CE increased with the increase in the fluence of the pre-pulse laser beam, and the CE saturated when the fluence exceeded respective predetermined values. Further, when the pulse duration was 10 ps, compared to the case where the pulse duration was 10 ns or 15 ns, higher CE was obtained and lower fluence was required to obtain that CE. When the pulse duration was 10 ps, if the fluence was increased from 2.6 J/cm² to 6.5 J/cm², the CE improved greatly, and if the fluence exceeded 6.5 J/cm², the rate of improving in the CE with respect to the increase in the fluence was reduced.

FIG. 4B is a graph showing a relationship between light intensity of the pre-pulse laser beam and the CE in the EUV light generation system 11. In FIG. 4B, the light intensity (W/cm²) of the pre-pulse laser beam is plotted along the horizontal axis, and the CE (%) is plotted along the vertical axis. The light intensity was calculated from the results shown in FIG. 4A. Here, the light intensity may be a value obtained by dividing the fluence of the pre-pulse laser beam by the pulse duration defined by the full width at half maximum.

In all of the cases where the pulse duration of the pre-pulse laser beam was 10 ps, 10 ns, and 15 ns, the CE increased with the increase in the light intensity of the pre-pulse laser beam. Further, higher CE was obtained when the pulse duration was 10 ps, compared to the case where the pulse duration was 10 ns or 15 ns. When the pulse duration was 10 ps, the CE greatly improved if the light intensity was in a range from 2.6×10 W/cm² m to 5.6×10¹¹ W/cm², and an even higher CE was obtained when the light intensity exceeded 5.6×10¹¹ W/cm².

As described above, by irradiating the target with the pre-pulse laser beam having pulse duration in the picosecond range to form the diffused target and irradiating the diffused target with the main pulse laser beam, it may be possible to improve the CE.

5.3 Relationship Between Pulse Duration and Status of Diffused Target

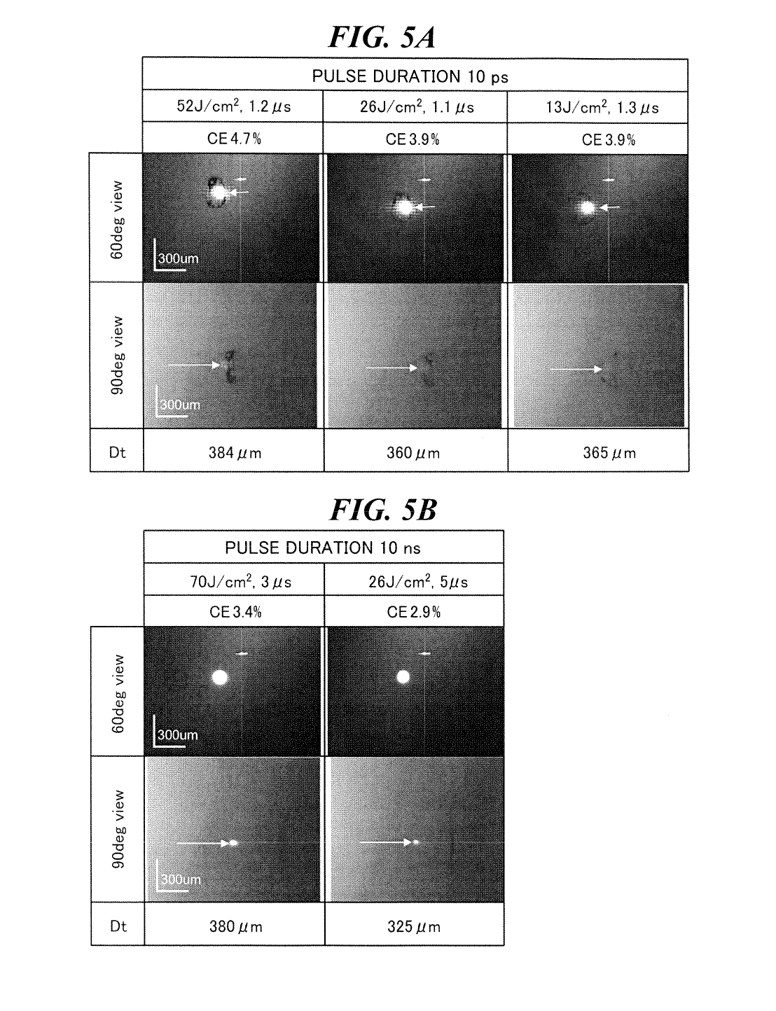

FIGS. 5A and 5B show photographs of a diffused target after the droplet target is irradiated with the pre-pulse laser beam in the EUV light generation system 11. Each of the photographs shown in FIGS. 5A and 5B was captured at the respective optimal third delay time to obtain the highest CE. In order to observe the diffusion status of the target, the target was not irradiated with the main pulse laser beam. FIG. 5A shows photographs in the cases where the pulse duration of the pre-pulse laser beam was set to 10 ps and the fluence thereof was set to three different values. That is, as in the description with reference to FIG. 3, FIG. 5A shows diffused targets (1) at the third delay time of 1.2 ps and the fluence of 52 J/cm², (2) at the third delay time of 1.1 ps and the fluence of 26 J/cm², and (3) at the third delay time of 1.3 μs and the fluence of 13 J/cm². FIG. 5B shows photographs in the cases where the pulse duration of the pre-pulse laser beam was set to 10 ns and the fluence thereof was set to two different values. That is, FIG. 5B shows diffused targets (1) at the third delay time of 3 ps and the fluence of 70 J/cm² and (2) at the third delay time of 5 ps and the fluence of 26 J/cm². In both of FIGS. 5A and 5B, the diffused targets were captured at an angle of 60 degrees and 90 degrees with respect to the traveling direction of the pre-pulse laser beam. An arrangement of the capturing equipment will be explained later.

The diameter Dt of the diffused target was 360 μm to 384 μm when the pulse duration of the pre-pulse laser beam was 10 ps, and the diameter Dt was 325 μm to 380 μm when the pulse duration of the pre-pulse laser beam was 10 ns. In other words, the diameter Dt of the diffused target was somewhat larger than 300 μm, which was the focusing spot diameter of the main pulse laser beam. However, the focusing spot diameter of the main pulse laser beam here may be the diameter of a portion having light intensity equal to or higher than 1/e² of the peak intensity at the focusing spot. Thus, even when the diameter Dt of the diffused target is 400 μm, the diffused target may be irradiated with most of the main pulse laser beam.

Further, when the pulse duration of the pre-pulse laser beam was 10 ps, compared to the case where the pulse duration was 10 ns, a shorter period of time was required for the diameter Dt of the diffused target to reach 300 μm. That is, when the pulse duration was 10 ps, compared to the case where the pulse duration was 10 ns, the diffusion speed of the target was faster.

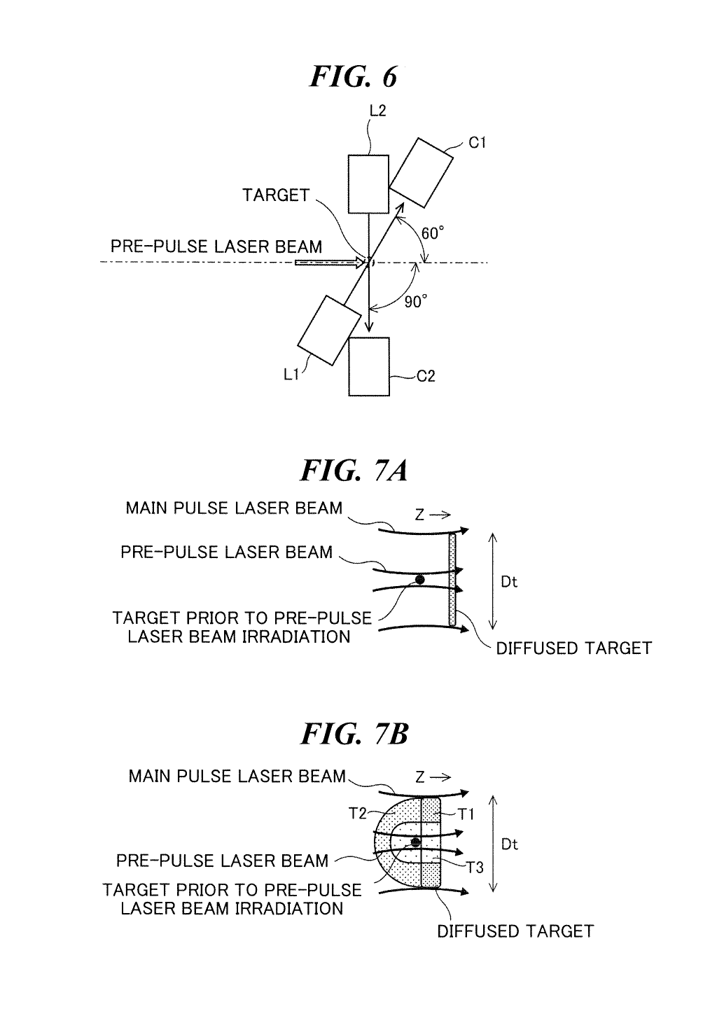

FIG. 6 schematically illustrates an arrangement of equipment used to capture the photographs shown in FIGS. 5A and 5B. As shown in FIG. 6, cameras C1 and C2 are respectively arranged at 60 degrees and 90 degrees to the traveling direction of the pre-pulse laser beam, and flash lamps L1 and L2 are respectively arranged to oppose the cameras C1 and C2 with reference to a point where a droplet target located therebetween is irradiated.

FIGS. 7A and 7B are sectional views schematically illustrating the diffused targets respectively shown in FIGS. 5A and 5B. As shown in FIGS. 5A and 7A, when the pulse duration of the pre-pulse laser beam was 10 ps, the droplet target diffused annularly in the direction in which the pre-pulse laser beam travels, and diffused in a dome shape in the opposite direction. More specifically, the diffused target included a first portion T1 where the target material diffused in an annular shape, a second portion T2 which is adjacent to the first portion T1 and in which the target material diffused in a dome shape, and a third portion T3 surrounded by the first portion T1 and the second portion T2. The density of the target material was higher in the first portion T1 than in the second portion T2, and the density of the target material was higher in the second portion T2 than in the third portion T3.

As shown in FIGS. 5B and 7B, when the pulse duration of the pre-pulse laser beam was 10 ns, the droplet target diffused in a disc shape or in an annular shape. Further, the droplet target diffused toward the Z direction in which the pre-pulse laser beam traveled.

When the pulse duration of the pre-pulse laser beam is in the nanosecond range, the target may be heated over a time period in the nanosecond range. During that time period, heat may be conducted to the inside of the target, then a part of the target may be vaporized by laser ablation, or the diffused target may move due to reaction force of the laser ablation. Meanwhile, when the pulse duration of the pre-pulse laser beam is in the picosecond range, the droplet target may be broken up instantaneously before the heat is conducted to the inside of the droplet target. Such a difference in the diffusion process of the droplet target may be a cause for the higher CE with a pre-pulse laser beam having the pulse duration in the picosecond range, rather than having the pulse duration in the nanosecond range as shown in FIG. 4A.

Further, when the pulse duration of the pre-pulse laser beam was in the picosecond range, compared to the case where the pulse duration was in the nanosecond range, the particle sizes of the particles of the target material included in the diffused target was smaller. If the target is diffused to such fine particles, the surface area of the target may become larger. Therefore, absorption of the laser beam to the target may become greater. Accordingly, in a case where the pulse duration of the pre-pulse laser beam is in the picosecond range, the diffused target may be turned into plasma more efficiently when the diffused target is irradiated with the main pulse laser beam. This may be a cause for the higher CE when the pulse duration is in the picosecond range, compared to the case where the pulse duration is in the nanosecond range.

5.4 Generation Process of the Diffused Target

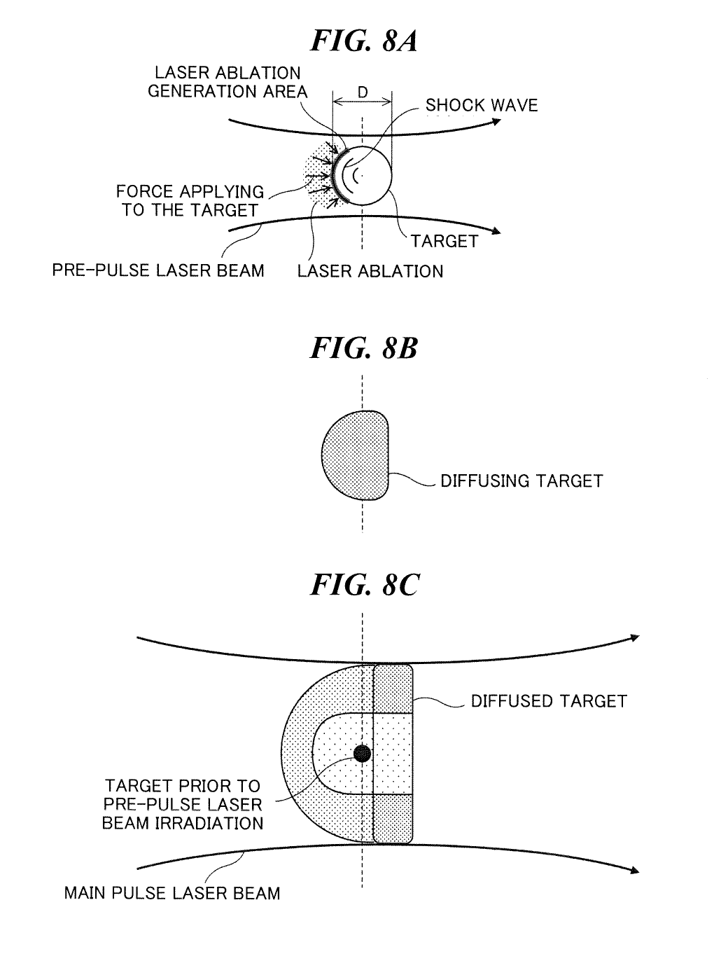

FIGS. 8A through 8C are sectional views schematically illustrating a process through which a diffused target is generated when a target is irradiated with a pre-pulse laser beam having pulse duration in the picosecond range. FIG. 8A shows a presumed status of the target material after a time in the picosecond range has passed since the target starts to be irradiated with the pre-pulse laser beam having pulse duration in the picosecond range. FIG. 8B shows a presumed status of the target material after a time in the nanosecond range has passed since the target starts to be irradiated with the pre-pulse laser beam having pulse duration in the picosecond range. FIG. 8C shows a status of a diffused target after approximately 1 ps has passed since the target starts to be irradiated with the pre-pulse laser beam having pulse duration in the picosecond range (see FIG. 7A).

As shown in FIG. 8A, when the droplet target is irradiated with the pre-pulse laser beam, a part of the energy of the pre-pulse laser beam may be absorbed into the target. As a result, laser ablation, accompanying a jet of ions or atoms generated substantially perpendicularly from the surface of the target irradiated with the pre-pulse laser beam, may occur. Then, the reaction force of the laser ablation may be applied perpendicularly onto the surface of the target irradiated with the pre-pulse laser beam.

This pre-pulse laser beam may have a fluence equal to or higher than 6.5 J/cm², and the irradiation may be completed within the picosecond range. Thus, the energy of the pre-pulse laser beam which the target receives per unit time may be relatively large (see FIG. 4B). Accordingly, a large amount of laser ablation may occur in a short period of time. Thus, the reaction force of the laser ablation may be large, and the shock wave may occur into the target.

The shock wave may travel substantially perpendicularly to the surface of the droplet target irradiated with the pre-pulse laser beam, and thus the shock wave may converge at substantially the center of the target. The curvature of the wavefront of the shock wave may be substantially the same as that of the surface of the target. As the shock wave converges, the energy may be concentrated, and when the concentrated energy exceeds a certain level, the droplet target may begin to break up.

It is presumed that the break-up of the target starts from a substantially semi-spherical wavefront of the shock wave whose energy has exceeded the aforementioned certain level as the shock wave converges. This may be a reason why the target has diffused as shown in FIG. 8C in a dome shape in a direction opposite to the direction in which the pre-pulse laser beam has struck the target.

When the shock wave converges at the center of the droplet target (see FIG. 8A), the energy may be at highest concentration, and the remaining part of the target may be broken up at once. This may be a reason why the target has diffused in an annular shape in the direction in which the pre-pulse laser beam has struck the target, as shown in FIG. 8C.

Although it is presumed that a large amount of laser ablation occurs in the situation shown in FIG. 8A, the time in which the laser ablation occurs may be short, and the time required for the shock wave to reach the center of the target may also be short. Then, as shown in FIG. 8B, it is presumed that the target has already started to break up after a time in the nanosecond range has passed. This may be a reason why the centroid of the diffused target does not differ much from the position of the center of the droplet target prior to being irradiated with the pre-pulse laser beam.

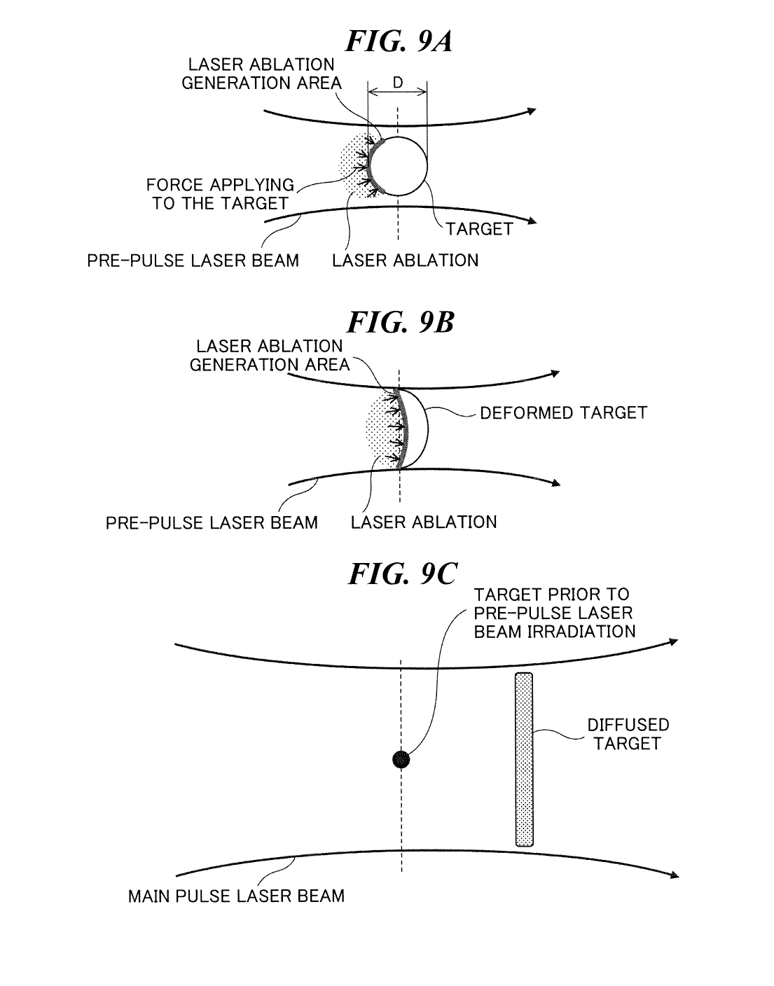

FIGS. 9A through 9C are sectional views schematically illustrating a process through which a diffused target is generated when a target is irradiated with a pre-pulse laser beam having pulse duration in the nanosecond range. FIG. 9A shows a presumed status of the target after a time in the picosecond range has passed since the target starts to be irradiated with the pre-pulse laser beam having pulse duration in the nanosecond range. FIG. 9B shows a presumed status of the target material after a time in the nanosecond range has passed since the target starts to be irradiated with the pre-pulse laser beam having pulse duration in the nanosecond range. FIG. 9C shows a status of a diffused target after a few microseconds have passed since the target starts to be irradiated with the pre-pulse laser beam having pulse duration in the nanosecond range (see FIG. 7B).

As shown in FIG. 9A, when the droplet target is irradiated with the pre-pulse laser beam, a part of the energy of the pre-pulse laser beam may be absorbed into the target. As a result, laser ablation, accompanying a jet of ions or atoms of the target material generated substantially perpendicularly from the surface of the target irradiated with the pre-pulse laser beam, may occur. Then, the reaction force of the laser ablation may be applied substantially perpendicularly onto the surface of the target irradiated with the pre-pulse laser beam.

This pre-pulse laser beam has pulse duration in the nanosecond range. This pre-pulse laser beam having the pulse duration in the nanosecond range may have fluence similar to that of the above-described pre-pulse laser beam having pulse duration in the picosecond range. However, since the target is irradiated with the pre-pulse laser beam over a time period in the nanosecond range, the energy of the pre-pulse laser beam which the target receives per unit time is smaller (see FIG. 4B).

A sonic speed V through liquid tin constituting the droplet target may be approximately 2,500 m/s. When the diameter D of the droplet target is 21 μm, a time Ts in which the sonic wave travels from the surface of the target irradiated with the pre-pulse laser beam to the center of the target may be calculated as follows:

$$\begin{matrix}Ts = ( D / 2 ) / V \\ = ( 21 \times {10}^{- 6} / 2 ) / 2500 \\ = 4.2 ns\end{matrix}$$

In the above-described measurement (see FIGS. 3 through 6), the fluence of the pre-pulse laser beam is not set to be high enough to vaporize the entire droplet target as ions or atoms by the laser ablation. Accordingly, when the target is irradiated with the pre-pulse laser beam having a pulse duration of 10 ns, the thickness of the target in the direction in which the pre-pulse laser beam travels may not be reduced by 21 μm within 10 ns. That is, the speed at which the thickness of the target decreases by being pressurized by the reaction force of the laser ablation may not exceed the sonic speed in liquid tin. Accordingly, a shock wave may not likely to occur inside the target.

The target irradiated with such a pre-pulse laser beam having pulse duration in the nanosecond range may deform into a flat or substantially disc shape due to the reaction force of the laser ablation acting on the target over a time period in the nanosecond range, as shown in FIG. 9B. Then, when the force causing the target to deform due to the reaction force of the laser ablation overcomes its surface tension, the target may break up. This may be a reason why the target has diffused in a disc shape or in an annular shape as shown in FIG. 9C.

Further, as stated above, the reaction force of the laser ablation may be applied on the target for a time period in the nanosecond range in the above-described case. Thus, this target may be accelerated by the reaction force of the laser ablation for an approximately 1,000 times longer period of time than in a case where the target is irradiated with the pre-pulse laser beam having pulse duration in the picosecond range. This may be a reason why the centroid of the diffused target is shifted from the center of the target in the direction in which the pre-pulse laser beam travels, as shown in FIG. 9C.

5.5 Range of the Pulse Duration

As stated above, when the target is irradiated with the pre-pulse laser beam having pulse duration in the picosecond range, the shock wave may occur inside the target and the target may break up from the vicinity of the center thereof. However, when the target is irradiated with the pre-pulse laser beam having pulse duration in the nanosecond range, the shock wave may not occur and the target may break up from the surface thereof.

Based on the above, the conditions for causing the shock wave to occur by the pre-pulse laser beam and the target to break up may be as follows. Here, the diameter D of the droplet target may be in the range of 10 μm to 40 μm.

When the diameter D of the droplet target is 40 μm, a time Ts required for the sonic wave to reach the center of the target from the surface thereof is calculated as follows:

$$\begin{matrix}Ts = ( D / 2 ) / V \\ = ( 40 \times {10}^{- 6} / 2 ) / 2500 \\ = 8 ns\end{matrix}$$

Preferably, the pulse duration Tp of the pre-pulse laser beam may be much shorter than the time Is required for the sonic wave to reach the center of the target from the surface thereof. Irradiating the target with the pre-pulse laser beam having a certain level of fluence within such a short period of time may cause a shock wave to occur, and the target may break up into fine particles.

A coefficient K is now be defined. The coefficient K may be set to determine the pulse duration Tp which is much smaller than the time Ts required for the sonic wave to reach the center of the target from the surface thereof. As in Expression (1) below, a value smaller than a product of the time Ts and the coefficient K may be set for the pulse duration Tp of the pre-pulse laser beam.

Tp<K×Ts Expression (1)

The coefficient K may, for example, be set to K=⅛. In other embodiments, the coefficient K may be set to K= 1/16. In yet other embodiments, the coefficient K may be set to K= 1/160.

When the diameter D of the droplet target is 40 μm, an optimum value for the pulse duration Tp of the pre-pulse laser beam may be induced from Expression (1) above as follows:

When K is set to K=⅛, Tp may be set to Tp<1 ns.

In other embodiments, when K is set to K= 1/16, Tp may be set to Tp<500 ps.

In yet other embodiments, when K is set to K= 1/160, Tp is set to Tp<50 ps.

5.6 Range of the Fluence

Referring back to FIG. 4A, when fluence of the pre-pulse laser beam having pulse duration in the picosecond range is set to be equal to or higher than 6.5 J/cm², the CE of 3.5% or higher may be obtained when the diffused target is irradiated with the main pulse laser beam in the optimal third delay time. When the fluence is set to be equal to or higher than 30 J/cm², the CE of 4% or higher is obtained. Further, when the fluence is set to be equal to or higher than 45 J/cm², the CE of 4.5% or higher is obtained. Accordingly, the fluence of the pre-pulse laser beam having the pulse duration in the picosecond range may be set to be equal to or higher than 6.5 J/cm². In other embodiments, the fluence may be set to 30 J/cm², and in yet other embodiments, the fluence may be set to 45 J/cm².

An energy Ed absorbed by the target when the target is irradiated with the pre-pulse laser beam having pulse duration in the picosecond range may be approximated from the following expression:

Ed≈F×A×π×(D/2)²

Here, F is the fluence of the pre-pulse laser beam, and A is an absorptance of the pre-pulse laser beam by the target. When the target material is liquid tin, and the wavelength of the pre-pulse laser beam is 1.06 μm, A is approximately 16%. D is the diameter of the droplet target.

Mass m of the target may be obtained from the following expression:

M=ρ×(4π/3)×(D/2)³

Here, ρ is the density of the target. When the target material is liquid tin, ρ may be approximately 6.94 g/cm³.

Then, energy Edp of the pre-pulse laser beam absorbed by the target per unit mass may be obtained from Expression (2) below:

$$\begin{matrix}Edp = Ed / m \\ \approx ( 3 / 2 ) \times F \times A / ( ρ D )\end{matrix} \qquad Expression ( 2 )$$

Accordingly, when the target material is liquid tin and the CE of 3.5% is obtained (i.e., the fluence F of the pre-pulse laser beam is 6.5 J/cm²), the energy Edp absorbed by the target per unit mass may be obtained from Expression (2) above as follows:

$$\begin{matrix}Edp \approx ( 3 / 2 ) \times 6.5 \times 0.16 / ( 6.94 \times 21 \times {10}^{- 4} ) \\ \approx 107 J \text{/} g\end{matrix}$$

When the CE of 4% is obtained (i.e., the fluence F of the pre-pulse laser beam is 30 J/cm²), the energy Edp absorbed by the target per unit mass may be obtained as follows:

$$\begin{matrix}Edp \approx ( 3 / 2 ) \times 30 \times 0.16 / ( 6.94 \times 21 \times {10}^{- 4} ) \\ \approx 494 J \text{/} g\end{matrix}$$

When the CE of 4.5% is obtained (i.e., the fluence F of the pre-pulse laser beam is 45 J/cm²), the energy Edp absorbed by the target per unit mass may be obtained as follows:

$$\begin{matrix}Edp \approx ( 3 / 2 ) \times 45 \times 0.16 / ( 6.94 \times 21 \times {10}^{- 4} ) \\ \approx 741 J \text{/} g\end{matrix}$$

Further, from Expression (2), the relationship between the fluence F of the pre-pulse laser beam and the energy Edp absorbed by the target per unit mass may be expressed as follows:

F≈(⅔)×Edp×ρ×D/A

Accordingly, the fluence F of the pre-pulse laser beam to obtain the CE of 3.5% using a given target material may be obtained using the aforementioned Edp as follows:

$$\begin{matrix}F \approx ( 2 / 3 ) \times 107 \times ρ \times D / A \\ \approx 71.3 ( ρ \times D / A )\end{matrix}$$

The fluence F of the pre-pulse laser beam to obtain the CE of 4% using a given target material may be obtained as follows:

$$\begin{matrix}F \approx ( 2 / 3 ) \times 494 \times ρ \times D / A \\ \approx 329 ( ρ \times D / A )\end{matrix}$$

The fluence F of the pre-pulse laser beam to obtain the CE of 4.5% using a given target material may be obtained as follows:

$$\begin{matrix}F \approx ( 2 / 3 ) \times 741 \times ρ \times D / A \\ \approx 494 ( ρ \times D / A )\end{matrix}$$

Accordingly, the value of the fluence F of the pre-pulse laser beam may be equal to or greater than the values obtained as above. Further, the value of the fluence F of the pre-pulse laser beam may be equal to or smaller than the value of the fluence of the main pulse laser beam. The fluence of the main pulse laser beam may, for example, be 150 J/cm² to 300 J/cm².

### 6. Pre-Pulse Laser Apparatus

6.1 General Configuration

As mentioned above, the pre-pulse laser beam for diffusing the target may preferably have short pulse duration in the picosecond range.

A mode-locked laser device may be used to generate a pulse laser beam having the short pulse duration. The mode-locked laser device may oscillate at a plurality of longitudinal modes with fixed phases with each other. When the plurality of longitudinal modes is combined with each other, a pulse laser beam having short pulse duration may be outputted. However, timing at which a pulse of the pulse laser beam is outputted from the mode-locked laser device may depend on timing at which a preceding pulse is outputted and depend on repetition rate in accordance with resonator length of the mode-locked laser device. Accordingly, it may not be easy to control the mode-locked laser device such that each pulse is outputted at desired timing. In order to achieve timing control of the pre-pulse laser beam with which the droplet target supplied to the chamber is irradiated, the pre-pulse laser device may have the following configuration.

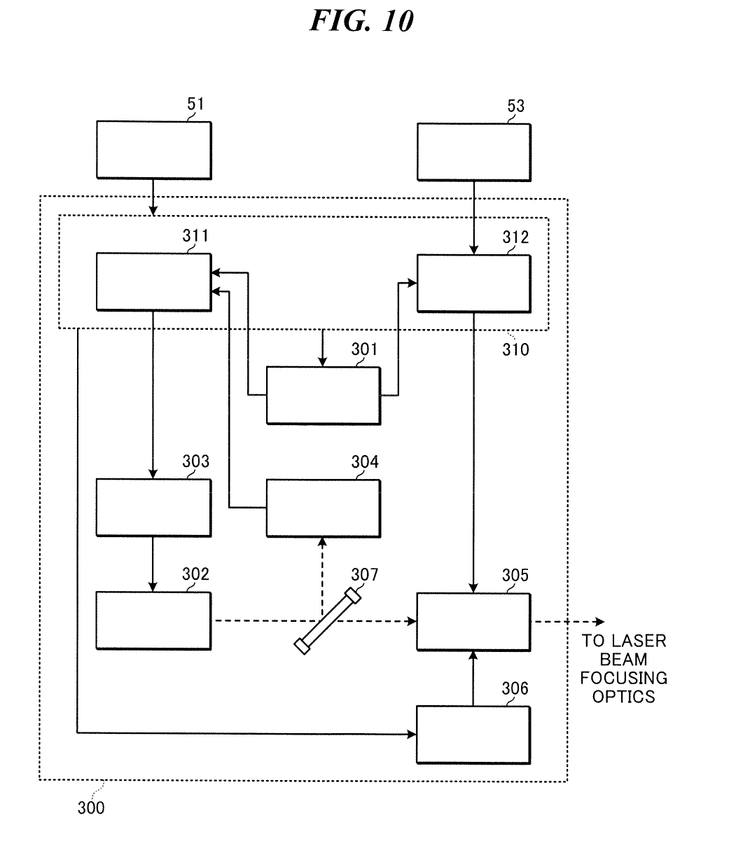

FIG. 10 schematically illustrates a configuration example of the pre-pulse laser apparatus 300 shown in FIG. 2. The pre-pulse laser apparatus 300 may include a clock generator 301, a mode-locked laser device 302, a resonator length controlling driver 303, a pulse laser beam detector 304, a regenerative amplifier 305, an excitation power supply 306, and a controller 310.

The clock generator 301 may output a clock signal, for example, at a repetition rate of 100 MHz. The mode-locked laser device 302 may oscillate at a plurality of longitudinal modes with fixed phases with each other. The mode-locked laser device 302 may output a pulse laser beam at a repetition rate of approximately 100 MHz, for example. The mode-locked laser device 302 may include an optical resonator which will be described later. The resonator length of the optical resonator may be adjusted through the resonator length controlling driver 303.

A beam splitter 307 may be provided in a beam path of the pulse laser beam outputted by the mode-locked laser device 302. The pulse laser beam detector 304 may be provided in one of beam paths of the pulse laser beam split by the beam splitter 307. The pulse laser beam detector 304 may be configured to detect the pulse laser beam and output a detection signal.

The regenerative amplifier 305 may be provided in the other of the beam paths of the pulse laser beam split by the beam splitter 307. The regenerative amplifier 305 may include an optical resonator in which the pulse laser beam is amplified by traveling back and forth several times. The regenerative amplifier 305 may take out the amplified pulse laser beam at timing when the pulse laser beam has traveled a predetermined number of times in the optical resonator. In the optical resonator of the regenerative amplifier 305, a laser medium (described later) may be disposed. Energy for exciting the laser medium may be provided via the excitation power supply 306 to the laser medium. The regenerative amplifier 305 may include a Pockels cell (described later) therein.

The controller 310 may include a phase adjuster 311 and an AND circuit 312. The phase adjuster 311 may carry out feedback control on the resonator length controlling driver 303 based on the clock signal from the clock generator 301 and the detection signal from the pulse laser beam detector 304.

Further, the controller 310 may control the regenerative amplifier 305 based on the clock signal from the clock generator 301 and the first timing signal from the delay circuit 53 mentioned in reference to FIG. 2. The AND circuit 312 may generate an AND signal of the clock signal and the first timing signal, and control a Pockels cell inside the regenerative amplifier 305 based on the AND signal.

6.2 Mode-Locked Laser Device

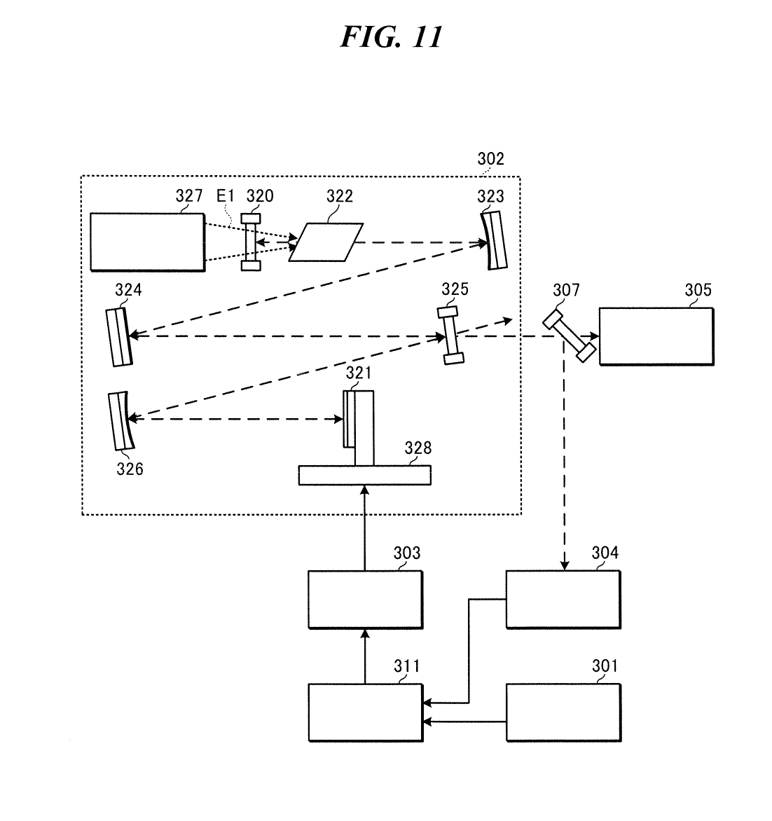

FIG. 11 schematically illustrates a configuration example of the mode-locked laser device shown in FIG. 10. The mode-locked laser device 302 may include an optical resonator formed by a flat mirror 320 and a saturable absorber mirror 321. In the optical resonator, a laser crystal 322, a concave mirror 323, a flat mirror 324, an output coupler mirror 325, and a concave mirror 326 may be provided in this order from the side of the flat mirror 320. The beam path in the optical resonator may be substantially parallel to the paper plane. The mode-locked laser device 302 may further include an excitation light source 327 configured to generate excitation light E1 to the laser crystal 322 from the outside of the optical resonator. The excitation light source 327 may include a laser diode to generate the excitation light E1.

The flat mirror 320 may be configured to transmit wavelength components of the excitation light E1 from the excitation light source 327 with high transmittance and reflect wavelength components of emitted light from the laser crystal 322 with high reflectance. The laser crystal 322 may be a laser medium that undergoes stimulated emission with the excitation light E1. The laser crystal 322 may, for example, be a neodymium-doped yttrium orthovanadate (Nd:YVO₄) crystal. Light emitted from the laser crystal 322 may include a plurality of longitudinal modes (frequency components). The laser crystal 322 may be arranged such that a laser beam is incident on the laser crystal 322 at a Brewster's angle.

The concave mirror 323, the flat mirror 324, and the concave mirror 326 may reflect the light emitted from the laser crystal 322 with high reflectance. The output coupler mirror 325 may be configured to transmit a part of the laser beam amplified in the optical resonator to the outside of the optical resonator and reflect the remaining part of the laser beam to be further amplified in the optical resonator. First and second laser beams that travel in different directions may be outputted through the output coupler mirror 325 to the outside of the optical resonator. The first laser beam includes a part of the light reflected by the flat mirror 324 and transmitted through the output coupler mirror 325. The second laser beam includes a part of the light reflected by the concave mirror 326 and transmitted through the output coupler mirror 325. The aforementioned beam splitter 307 may be provided in a beam path of the first laser beam. A beam dump (not shown) may be provided in a beam path of the second laser beam.

The saturable absorber mirror 321 may be formed such that a reflective layer is laminated on a mirror substrate and a saturable absorber layer is laminated on the reflective layer. In the saturable absorber mirror 321, the saturable absorber layer may absorb incident light while light intensity thereof is lower than a predetermined threshold value. When the light intensity of the incident light increases up to the threshold value or more, the saturable absorber layer may transmit the incident light and the reflective layer may reflect the incident light. With this configuration, only high intensity pulses of the laser beam may be reflected by the saturable absorber mirror 321. The high intensity pulses may be instantaneously generated when phases of the plurality of longitudinal modes match with each other.

In this way, pulses of the laser beam in which phases of the plurality of longitudinal modes are fixed with each other may travel back and forth in the optical resonator and such pulses may be amplified. This situation may be referred to as mode-lock. The amplified pulses may be periodically outputted through the output coupler mirror 325 as a pulse laser beam. The repetition rate of this pulse laser beam may correspond to an inverse of a time period for a pulse to travel once back and forth in the optical resonator. For example, when the resonator length L is 1.5 m and the speed of light c is 3×10⁸ m/s, the repetition rate f may be 100 MHz as calculated by the following expression:

$$\begin{matrix}f = c / ( 2 L ) \\ = ( 3 \times {10}^{8} ) / ( 2 \times 1.5 ) \\ = 100 MHz\end{matrix}$$

Since the laser crystal 322 is arranged as shown in FIG. 11 at the Brewster's angle to the laser beam, the outputted pulse laser beam may be a linearly polarized laser beam in which polarization direction is parallel to the paper plane.

The saturable absorber mirror 321 may be held by a mirror holder, and this mirror holder may be movable by a linear stage 328 in a travelling direction of the laser beam. The travelling direction of the laser beam may be a horizontal direction of FIG. 11. The linear stage 328 may be driven by the resonator length controlling driver 303. As the saturable absorber mirror 321 is moved in the travelling direction of the laser beam, the resonator length may be controlled to adjust the repetition rate of the pulse laser beam.

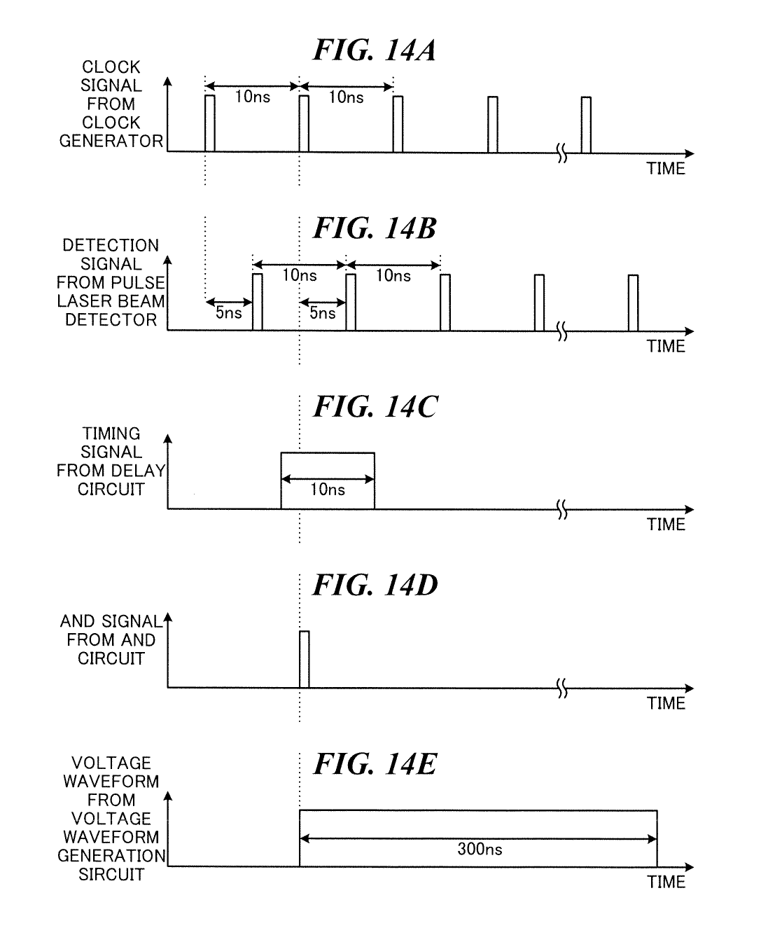

As mentioned above, the phase adjuster 311 may be configured to control the resonator length controlling driver 303 based on the clock signal from the clock generator 301 and on the detection signal from the pulse laser beam detector 304. More specifically, the phase adjuster 311 may detect a phase difference between the clock signal and the detection signal, and control the resonator length controlling driver 303 so that the clock signal and the detection signal are in synchronization at a certain phase difference. The phase difference between the clock signal and the detection signal may be referred to as a fourth delay time. The fourth delay time will be explained later with reference to FIGS. 14A and 14B.

6.3 Regenerative Amplifier

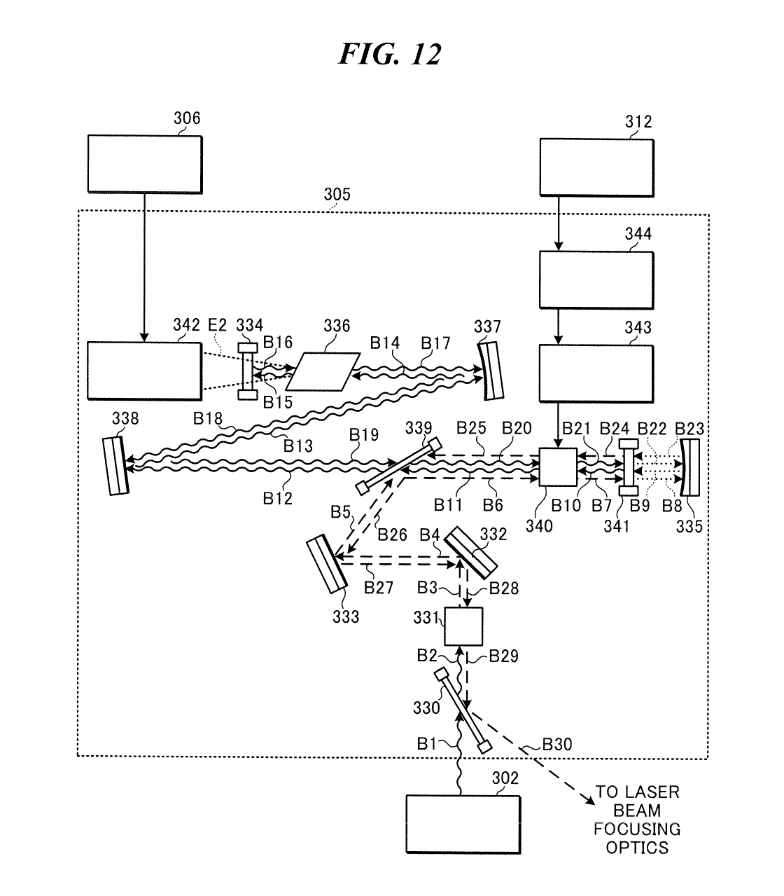

FIG. 12 schematically illustrates a configuration example of the regenerative amplifier 305 shown in FIG. 10. The regenerative amplifier 305 may include an optical resonator formed by a flat mirror 334 and a concave mirror 335. In the optical resonator, a laser crystal 336, a concave mirror 337, a flat mirror 338, a polarization beam splitter 339, a Pockels cell 340, and a quarter wave plate 341 may be provided in this order from the side of the flat mirror 334. The resonator length of the optical resonator in the regenerative amplifier 305 may be shorter than that of the optical resonator in the mode-locked laser device 302. Further, the regenerative amplifier 305 may include an excitation light source 342 configured to introduce excitation light E2 to the laser crystal 336 from the outside of the optical resonator. The excitation light source 342 may include a laser diode to generate the excitation light E2. Further, the regenerative amplifier 305 may include a polarization beam splitter 330, a Faraday optical isolator 331, and flat mirrors 332 and 333. The Faraday optical isolator 331 may include a Faraday rotator (not shown) and a half-wave plate (not shown).

The flat mirror 334 may be configured to transmit wavelength components of the excitation light E2 from the excitation light source 342 with high transmittance and reflect wavelength components of emitted light from the laser crystal 336 with high reflectance. The laser crystal 336 may be a laser medium excited by the excitation light E2. The laser crystal 336 may, for example, be a neodymium-doped yttrium aluminum garnet (Nd:YAG) crystal. The laser crystal 336 may be arranged such that a laser beam is incident on the laser crystal 336 at a Brewster's angle. When a seed beam outputted from the mode-locked laser device 302 is incident on the laser crystal 336 excited by the excitation light E2, the seed beam may be amplified through stimulated emission.

6.3.1 when Voltage is not Applied to the Pockels Cell

The polarization beam splitter 330 may be provided in a beam path of a pulse laser beam B1 from the mode-locked laser device 302. The polarization beam splitter 330 may be arranged such that light receiving surfaces thereof are perpendicular to the paper plane. The polarization beam splitter 330 may be configured to transmit a linearly polarized pulse laser beam B1, polarized in a direction parallel to the paper plane, with high transmittance. As described later, the polarization beam splitter 330 may reflect a linearly polarized pulse laser beam B29 polarized in a direction perpendicular to the paper plane with high reflectance.

The Faraday optical isolator 331 may be provided in a beam path of a pulse laser beam B2 which was transmitted through the polarization beam splitter 330 and came from the lower side in FIG. 12. The Faraday optical isolator 331 may rotate the polarization direction of the linearly polarized pulse laser beam B2, which came from the lower side in FIG. 12, by 90 degrees and output as a pulse laser beam B3. As described later, the Faraday optical isolator 331 may transmit a pulse laser beam B28, which may come from the upper side in FIG. 12, toward the polarization beam splitter 330 without rotating the polarization direction thereof.

The flat mirror 332 may be provided in a beam path of the pulse laser beam B3 transmitted through the Faraday optical isolator 331. The flat mirror 332 may reflect the pulse laser beam B3 with high reflectance. The flat mirror 333 may reflect a pulse laser beam B4 reflected by the flat mirror 332 with high reflectance.

The polarization beam splitter 339 in the optical resonator may be provided in a beam path of a pulse laser beam B5 reflected by the flat mirror 333. The polarization beam splitter 339 may be provided such that the light receiving surfaces thereof are perpendicular to the paper plane. The pulse laser beam B5 may be incident on a right side receiving surface of the polarization beam splitter 339. The polarization beam splitter 339 may reflect the linearly polarized pulse laser beam B5 polarized in a direction perpendicular to the paper plane with high reflectance to thereby guide it into the optical resonator as a pulse laser beam B6. As described later, the polarization beam splitter 339 may transmit a linearly polarized pulse laser beam B11 polarized in a direction parallel to the paper plane with high transmittance.

The Pockels cell 340, the quarter wave plate 341 and the concave mirror 335 may be disposed at the right side of the polarization beam splitter 339 in the optical path of the optical resonator. The flat mirror 334, the laser crystal 336, the concave mirror 337 and the flat mirror 338 may be disposed at the left side of the polarization beam splitter 339 in the optical path of the optical resonator.

Voltage may be applied to the Pockels cell 340 by a high voltage power supply 343. When the voltage is not applied to the Pockels cell 340 by the high voltage power supply 343, the Pockels cell 340 may transmit the pulse laser beam B6 to output a pulse laser beam B7 without rotating the polarization direction. The situation in which the high voltage power supply 343 does not apply the voltage to the Pockels cell 340 may be referred to as “voltage OFF” and a situation in which the high voltage power supply 343 applies the voltage may be referred to as “voltage ON”.

The quarter wave plate 341 may be arranged such that light receiving surfaces thereof are perpendicular to the paper plane. Moreover, the quarter wave plate 341 may be arranged such that the optical axis thereof is tilted, within a plane perpendicular to the incident laser beam, by 45 degrees to the paper plane. The pulse laser beam B7, being incident on the quarter wave plate 341, may have a first polarization component parallel to the optical axis of the quarter wave plate 341, and have a second polarization component perpendicular to both of the optical axis of the quarter wave plate 341 and a traveling direction of the pulse laser beam B7. When the first and second polarization components are combined, the resultant vector may be parallel to the polarization direction of the pulse laser beam B7 and perpendicular to the paper plane.

The quarter wave plate 341 may have a double refraction property to transmit the first and second polarization components through different optical paths. As a result, the quarter wave plate 341 may sift the phase of the second polarization component by ¼ wavelengths with respect to the phase of the first polarization component when the quarter wave plate 341 transmits the pulse laser beam B7. The concave mirror 335 may reflect a pulse laser beam B8 from the quarter wave plate 341 with high reflectance. A pulse laser beam B9 reflected by the concave mirror 335 may be transmitted again through the quarter wave plate 341. Therefore, the quarter wave plate 341 may further shift the phase of the second polarization component by ¼ wavelengths with respect to the phase of the first polarization component. That is, the pulse laser beam B7, by being transmitted twice through the quarter wave plate 341, the phase of the second polarization component may be shifted by ½ wavelengths in total with respect to the phase of the first polarization component. As a result, the polarization direction of the pulse laser beam B7, linearly polarized in a direction perpendicular to the paper plane, may be rotated by 90 degrees and may be incident on the Pockels cell 340 as a pulse laser beam B10, linearly polarized in a direction parallel to the paper plane.

As stated above, when the voltage from the high voltage power supply 343 is not applied to the Pockels cell 340, the Pockels cell 340 may transmit the incident pulse laser beam without rotating the polarization direction. Accordingly, a pulse laser beam B11 transmitted through the Pockels cell 340 may be incident on the polarization beam splitter 339 as a linearly polarized pulse laser beam polarized in a direction parallel to the paper plane. The polarization beam splitter 339 may transmit the pulse laser beam B11 linearly polarized in the direction parallel to the paper plane with high transmittance.

The flat mirror 338 may reflect with high reflectance a pulse laser beam B12 which was transmitted through the polarization beam splitter 339. The concave mirror 337 may reflect a pulse laser beam B13 from the flat mirror 338 with high reflectance. The laser crystal 336 may amplify and transmit a pulse laser beam B14 as a seed beam from the concave mirror 337.

The flat mirror 334 may reflect a pulse laser beam B15 from the laser crystal 336 with high reflectance back to the laser crystal 336 as a pulse laser beam B16. A pulse laser beam B17 amplified by the laser crystal 336 may be incident on the concave mirror 337. The pulse laser beam may then be incident on the flat mirror 338, then be incident on the polarization beam splitter 339, then be incident on the Pockels cell 340, and then be incident on the quarter wave plate 341 as a pulse laser beam B21. The pulse laser beam B21 may be transmitted through the quarter wave plate 341, then be reflected by the concave mirror 335, and then be transmitted again through the quarter wave plate 341, to thereby be converted into a linearly polarized pulse laser beam B24 polarized in a direction perpendicular to the paper plane. The pulse laser beam B24 may be transmitted through the Pockels cell 340, then be reflected by the polarization beam splitter 339, and outputted as a pulse laser beam B26 to the outside of the optical resonator.

The pulse laser beam B26 may be reflected by the flat mirror 333, then be reflected by the flat mirror 332, and then be incident on the Faraday optical isolator 331 as a pulse laser beam B28 from the upper side in FIG. 12. The Faraday optical isolator 331 may transmit the linearly polarized pulse laser beam B28, without rotating the polarization direction thereof, as a pulse laser beam B29. The polarization beam splitter 330 may reflect the linearly polarized pulse laser beam B29 polarized in a direction perpendicular to the paper plane with high reflectance.

A pulse laser beam B30 reflected by the polarization beam splitter 330 may be guided through the laser beam focusing optics 22a shown in FIG. 2 to the plasma generation region 25. However, the pulse laser beam B30 outputted after traveling only once in the optical resonator in the regenerative amplifier 305 may have low light intensity. Even when a droplet target is irradiated with the pulse laser beam B30, the droplet target may not be diffused or turned into plasma.

6.3.2 when Voltage is Applied to the Pockels Cell

The high voltage power supply 343 may turn ON the voltage to the Pockels cell 340 at given timing after one pulse of the pulse laser beam B11 is once transmitted through the Pockels cell 340 and before the pulse is then incident on the Pockels cell 340 as the pulse laser beam B20. When the voltage is applied to the Pockels cell 340 by the high voltage power supply 343, the Pockels cell 340 may, similarly to the quarter wave plate 341, shift the phase of the second polarization component by ¼ wavelengths with respect to the phase of the first polarization component.

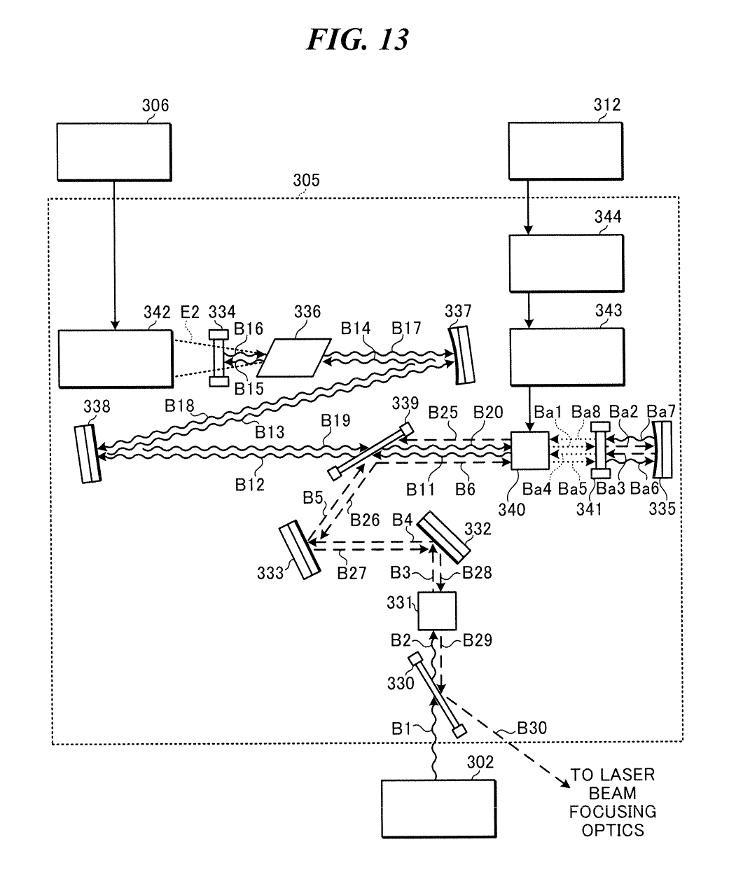

FIG. 13 schematically illustrates a beam path in the regenerative amplifier 305 shown in FIG. 12 when the voltage is applied to the Pockels cell 340. In this situation, the pulse laser beam B20 may be transmitted through the Pockels cell 340 twice and the quarter wave plate 341 twice, as indicated by pulse laser beams Ba1, Ba2, Ba3, and Ba4, and may return as the pulse laser beam B11. The pulse laser beam B11 that has been transmitted through the quarter wave plate 341 twice and transmitted through the Pockels cell 340 twice to which the voltage is applied may have its polarization direction oriented toward the same direction as that of the pulse laser beam B20. Accordingly, the pulse laser beam B11 may be transmitted through the polarization beam splitter 339 and be amplified by the laser crystal 336. While the voltage is applied to the Pockels cell 340 by the high voltage power supply 343, this amplification operation may be repeated.

After the amplification operation is repeated, the high voltage power supply 343 may set the voltage applied to the Pockels cell 340 to OFF at given timing after one pulse of the pulse laser beam B11 is transmitted through the Pockels cell 340 and before the pulse is incident on the Pockels cell 340 as the pulse laser beam B20. As stated above, when the voltage is not applied to the Pockels cell 340 from the high voltage power supply 343, the Pockels cell 340 may not rotate polarization direction of the incident pulse laser beam. Accordingly, the pulse laser beam B20 incident on the left side surface of the Pockels cell 340 when the voltage is not applied thereto may have its polarization direction rotated only by 90 degrees as it is transmitted through the quarter wave plate 341 twice as the pulse laser beams B21, B22, B23, and B24 shown in FIG. 12. Thus, the pulse laser beam after the amplification operation is repeated may be incident on the right side receiving surface of the polarization beam splitter 339 as the linearly polarized pulse laser beam B25 polarized in a direction perpendicular to the paper plane and be outputted to the outside of the optical resonator.

While the voltage is applied to the Pockels cell 340 and the amplification operation is repeated as shown in FIG. 13, a pulse laser beam B1 newly outputted from the mode-locked laser device 302 may be incident on the Pockels cell 340 as the linearly polarized pulse laser beam B6 polarized in a direction perpendicular to the paper plane. While the voltage is applied to the Pockels cell 340, the pulse laser beam B6 may be transmitted through the quarter wave plate 341 twice and the Pockels cell 340 twice as the pulse laser beams Ba5, Ba6, Ba1, and Ba8 and return as the pulse laser beam B25. In this situation, the pulse laser beam B25 may have the same polarization direction as that of the pulse laser beam B6. Accordingly, the pulse laser beam B25 may be reflected by the right side receiving surface of the polarization beam splitter 339, and outputted as a pulse laser beam B26 to the outside of the optical resonator without being amplified even once.

Timing at which the high voltage power supply 343 sets the voltage applied to the Pockels cell 340 to ON/OFF may be determined by the AND signal of the clock signal and the timing signal described above. The AND signal may be supplied from the AND circuit 312 to the voltage waveform generation circuit 344 in the regenerative amplifier 305. The voltage waveform generation circuit 344 may generate voltage waveform using the AND signal as a trigger, and supply this voltage waveform to the high voltage power supply 343. The high voltage power supply 343 may generate the pulse voltage in accordance with the voltage waveform and apply this pulse voltage to the Pockels cell 340. The timing signal, the AND signal, and the voltage waveform by the voltage waveform generation circuit 344 will be described later with reference to FIGS. 14C through 14E.

6.4 Timing Control

FIGS. 14A through 14E are timing charts of various signals in the pre-pulse laser apparatus 300 shown in FIG. 10. FIG. 14A is a timing chart of the clock signal outputted from the clock generator 301. The clock generator 301 may be configured to output the clock signal, for example, at a repetition rate of 100 MHz. In this case, the interval of the pulses may be 10 ns.

FIG. 14B is a timing chart of the detection signal outputted from the pulse laser beam detector 304. The repetition rate of the detection signal from the pulse laser beam detector 304 may depend on the repetition rate of the pulse laser beam outputted from the mode-locked laser device 302. The repetition rate of the pulse laser beam from the mode-locked laser device 302 may be adjusted by controlling the resonator length of the mode-locked laser device 302. In this example, the repetition rate of the pulse laser beam may be approximately 100 MHz. By fine-tuning the repetition rate of the pulse laser beam, the phase difference from the clock signals shown in FIG. 14A may be adjusted. Thus, a feedback control may be carried out on the mode-locked laser device 302 so that the detection signal of the pulse laser beam is in synchronization with the clock signal shown in FIG. 14A at a fourth delay time of, for example, 5 ns.

FIG. 14C is a timing chart of the first timing signal outputted from the delay circuit 53. As stated above, the first timing signal from the delay circuit 53 may be a signal which represents the timing at which the first delay time has passed from the timing of the target detection signal by the target sensor 4. The repetition rate of the first timing signal may depend on the repetition rate of the droplet targets outputted from the target supply device 26. The droplet targets may be outputted from the target supply device 26, for example, at a repetition rate of approximately 100 kHz. The pulse duration of the first timing signal may be substantially equal to an interval between pulses of the clock signal shown in FIG. 14A. Therefore, the pulse duration of the first timing signal may be, for example, 10 ns.

FIG. 14D is a timing chart of the AND signal outputted from the AND circuit 312. The AND signal from the AND circuit 312 may be a signal of a logical product of the clock signal and the first timing signal. When the pulse duration of the first timing signal is substantially the same as the interval of the clock signal, a single pulse of the AND signal may be generated for a single pulse of the first timing signal. The AND signal may be generated to be substantially in synchronization with some of multiple pulses of the clock signal.

FIG. 14E is a timing chart of the voltage waveform outputted from the voltage waveform generation circuit 344. The voltage waveform from the voltage waveform generation circuit 344 may be substantially in synchronization with the AND signal from the AND circuit 312. The voltage waveform may, for example, have a pulse duration of 300 ns. For example, if the resonator length of the regenerative amplifier 305 is 1 m, it may take 300 ns for the pulse laser beam at the speed of light of 3×10⁸ m/s to travel 50 times back and forth in the optical resonator. By setting pulse duration of the voltage waveform, the number of times of traveling of the pulse laser beam in the optical resonator of the regenerative amplifier 305 may be set.

With the above timing control, the pulse laser beam from the mode-locked laser device 302 may be in synchronization with the clock signal at the fourth delay time, and the AND signal may be in synchronization with some of the pulses of the clock signal. Thus, while the pulse laser beam travels in a specific section of the optical resonator in the regenerative amplifier 305, the voltage applied to the Pockels cell 340 from the high voltage power supply 343 may be set to ON or OFF. Accordingly, only desired pulses in the pulse laser beam from the mode-locked laser device 302 may be amplified to desired light intensity, and outputted to strike a droplet target.

Further, with the above-described timing control, timing of pulses from the regenerative amplifier 305 may be controlled with resolving power in accordance with the interval of the pulses from the mode-locked laser device 302. For example, a droplet target which is outputted from the target supply device 26 and is traveling inside the chamber 2 at a speed of 30 m/s to 60 m/s may move 0.3 μm to 0.6 μm in 10 ns, which is the interval of the pulses from the mode-locked laser device 302. When the diameter of the droplet target is 20 μm, the resolving power of 10 ns may be sufficient to irradiate the droplet target with the pulse laser beam.

6.5 Examples of Laser Medium

In the above-described example, an Nd:YVO₄ crystal is used as the laser crystal 322 in the mode-locked laser device 302, and an Nd:YAG crystal is used as the laser crystal 336 in the regenerative amplifier 305. However, this disclosure is not limited to those using such crystals.

As one example, an Nd:YAG crystal may be used as a laser crystal in both of the mode-locked laser device 302 and the regenerative amplifier 305.

As another example, a Titanium-doped Sapphire (Ti:Sapphire) crystal may be used as a laser crystal in either one or both of the mode-locked laser device 302 and the regenerative amplifier 305.

As yet another example, a ruby crystal may be used as a laser crystal in either one or both of the mode-locked laser device 302 and the regenerative amplifier 305.

As yet another example, a dye cell may be used as a laser medium in either one or both of the mode-locked laser device 302 and the regenerative amplifier 305.

As still another example, a triply ionized neodymium-doped glass (Nd³⁺:glass) may be used as a laser medium in either one or both of the mode-locked laser device 302 and the regenerative amplifier 305.

### 7. Main Pulse Laser Apparatus

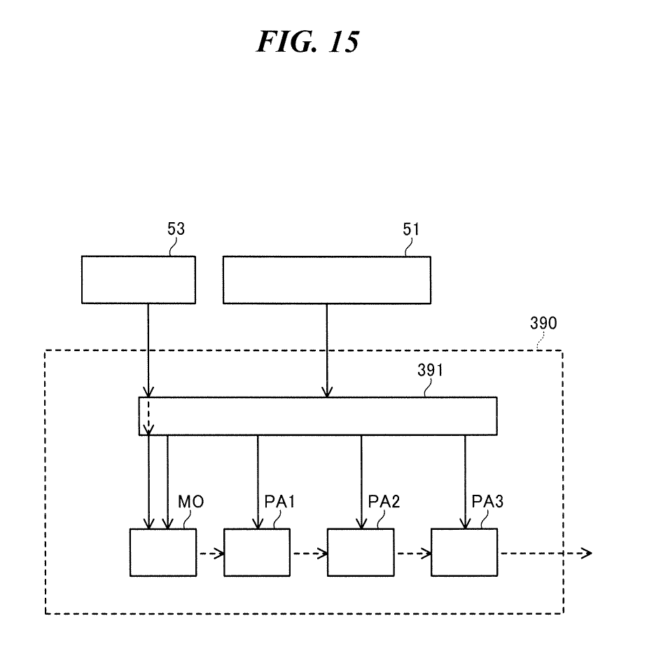

FIG. 15 schematically illustrates an exemplary configuration of the main pulse laser apparatus 390 shown in FIG. 2. The main pulse laser apparatus 390 may include a master oscillator MO, amplifiers PA1, PA2, and PA3, and a controller 391.

The master oscillator MO may be a CO₂ laser apparatus in which a CO₂ gas is used as a laser medium, or may be a quantum cascade laser apparatus configured to oscillate in a wavelength region corresponding to that of the CO₂ laser apparatus. The amplifiers PA1, PA2, and PA3 may be provided in series in a beam path of a pulse laser beam outputted from the master oscillator MO. Each of the amplifiers PA1, PA2, and PA3 may include a laser chamber (not shown) in which a CO₂ gas is contained as a laser medium, a pair of electrodes (not shown) provided inside the laser chamber, and a power supply (not shown) configured to apply voltage between the pair of electrodes. In the following description, the CO₂ gas may be used as a laser medium gas after being diluted with other gases such as nitrogen, helium, neon, or xenon gas.

The controller 391 may control the master oscillator MO and the amplifiers PA1, PA2, and PA3 based on a control signal from the EUV controller 51. The controller 391 may output the timing signal from the delay circuit 53 to the master oscillator MO. The timing signal from the delay circuit 53 may be the second timing signal mentioned above. The master oscillator MO may output each pulse of the pulse laser beam in accordance with each pulse of the timing signal serving as a trigger. The pulse laser beam may be amplified in the amplifiers PA1, PA2, and PA3. Thus, the main pulse laser apparatus 390 may output the main pulse laser beam in synchronization with the timing signal from the delay circuit 53.

### 8. An EUV Light Generation System Including a Device to Control the Second Delay Time

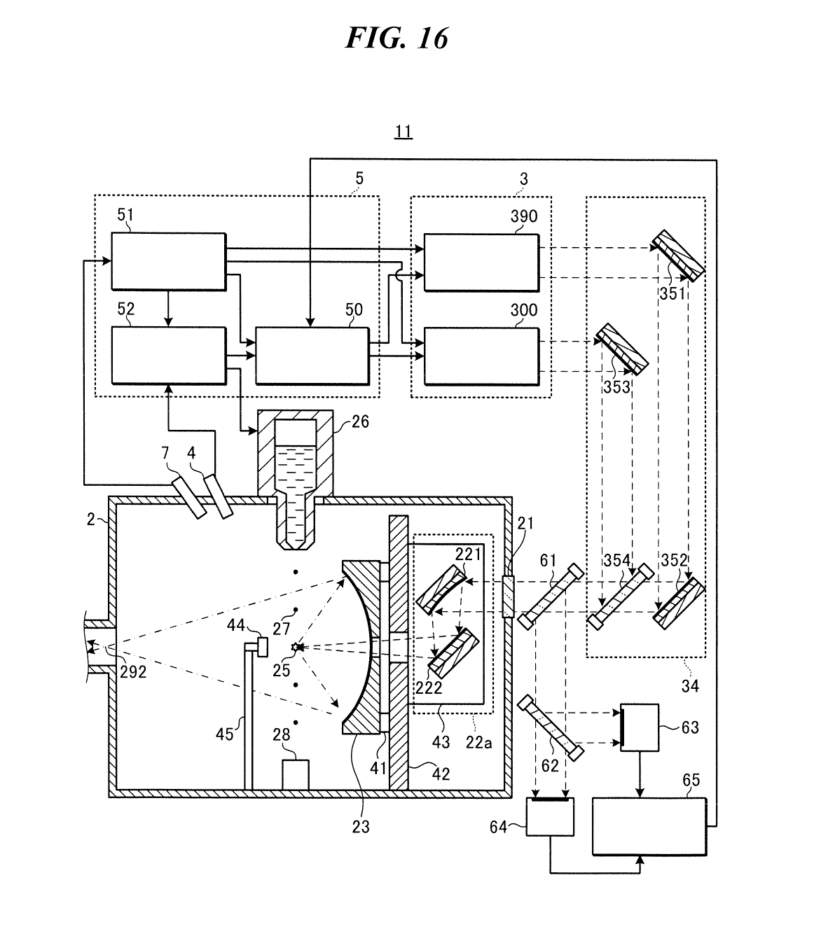

FIG. 16 is a partial sectional view schematically illustrating an exemplary configuration of the EUV light generation system 11 according to a second embodiment. The EUV light generation system 11 according to the second embodiment may include beam splitters 61 and 62, optical sensors 63 and 64, and a delay time measuring unit 65. The EUV light generation system 11 may also include a delay time control device 50 instead of the delay circuit 53 shown in FIG. 2. The other points may be similar to those of the first embodiment.

The beam splitter 61 may be provided in the beam paths of the pre-pulse laser beam and the main pulse laser beam between the dichroic mirror 354 and the laser beam focusing optics 22a. The beam splitter 61 may be coated with a film configured to transmit the pre-pulse laser beam and the main pulse laser beam at high transmittance and reflect a part of the pre-pulse laser beam and the main pulse laser beam.

The beam splitter 62 may be provided in the beam paths of the pre-pulse laser beam and the main pulse laser beam reflected by the beam splitter 61. The beam splitter 62 may be coated with a film configured to reflect the pre-pulse laser beam at high reflectance and transmit the main pulse laser beam at high transmittance.

The optical sensor 63 may be provided in a beam path of the pre-pulse laser beam reflected by the beam splitter 62. The optical sensor 64 may be provided in a beam path of the main pulse laser beam transmitted through the beam splitter 62. The optical sensors 63 and 64 may be provided such that the respective optical lengths from the beam splitter 62 are equal to each other. The optical sensor 63 may detect the pre-pulse laser beam and output a detection signal. The optical sensor 63 may include a fast-response photodiode configured to detect the pre-pulse laser beam having a wavelength of 1.06 μm. The optical sensor 64 may detect the main pulse laser beam and output another detection signal. The optical sensor 64 may include a fast-response thermoelectric element configured to detect the main pulse laser beam having a wavelength of 10.6 μm.

The delay time measuring unit 65 may be connected to the optical sensors 63 and 64 through respective signal lines. The delay time measuring unit 65 may receive detection signals from the respective optical sensors 63 and 64, and measure a third delay time δT of the detection of the main pulse laser beam from the detection of the pre-pulse laser beam based on the received detection signals. The delay time measuring unit 65 may output the measured third delay time δT to the delay time control device 50.

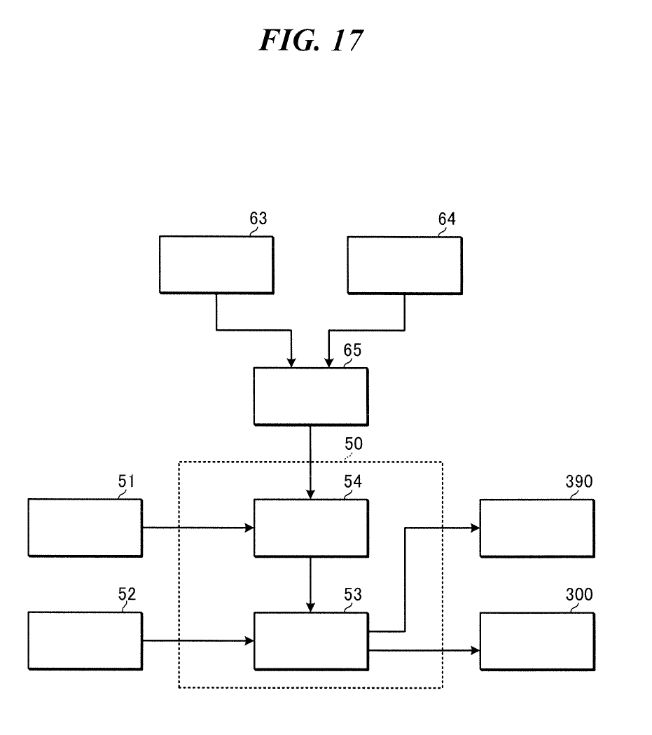

FIG. 17 schematically illustrates an exemplary configuration of a delay time control device shown in FIG. 16. The delay time control device 50 may include the delay circuit 53 and a controller 54. The delay circuit 53 may output to the pre-pulse laser apparatus 300 the first timing signal which represents that the first delay time has passed from the target detection signal outputted from the target controller 52. Further, the delay circuit 53 may output to the main pulse laser apparatus 390 the second timing signal which represents that the second delay time δTo has passed from the first timing signal. The second delay time δTo may be variable.

The controller 54 may receive a target value δTt of the third delay time from the EUV controller 51. Further, the controller 54 may receive the measured third delay time ST from the delay time measuring unit 65. The controller 54 may be configured to control the delay circuit 53 to modify the second delay time δTo based on a difference between the third delay time δT and the target value δTt.

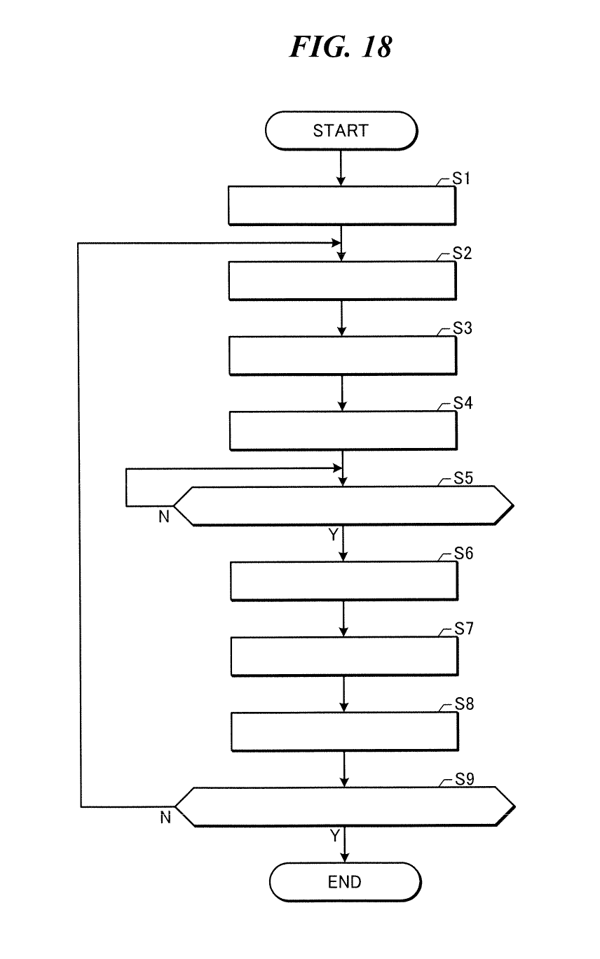

FIG. 18 is a flowchart showing an exemplary operation of the controller shown in FIG. 17. The controller 54 may carry out a feedback control on the delay circuit 53 based on the difference between the third delay time δT and the target value δTt.

The controller 54 may first receive an initial value of a delay parameter α from the EUV controller 51 (Step S1). The initial value of the delay parameter α may be calculated from the following expression:

α=(Lm×Lp)/c

Here, Lm may be a beam path length of the main pulse laser beam from the master oscillator MO (see FIG. 15) of the main pulse laser apparatus 390 to the plasma generation region 25, Lp may be a beam path length of the pre-pulse laser beam from the regenerative amplifier 305 (see FIG. 10) of the pre-pulse laser apparatus 300 to the plasma generation region 25, and c may be the speed of light (3×10⁸ m/s).

The main pulse laser apparatus 390 may include a larger number of amplifiers than the pre-pulse laser apparatus 300 in order to output the main pulse laser beam having a higher beam energy than the pre-pulse laser beam. Accordingly, the beam path length Lm of the main pulse laser beam may be longer than the beam path length Lp of the pre-pulse laser beam, and the delay parameter α may be greater than 0.

Then, the controller 54 may receive a target value δTt of the third delay time from the EUV controller 51 (Step S2). The controller 54 may then calculate the second delay time δTo by subtracting the delay parameter α from the target value δTt (Step S3). Subsequently, the controller 54 may send the calculated second delay time δTo to the delay circuit 53 (Step S4).

Thereafter, the controller 54 may determine whether or not the pre-pulse laser apparatus 300 and the main pulse laser apparatus 390 have oscillated (Step S5). When either of these laser apparatuses has not oscillated (Step S5; NO), the controller 54 may stand by until these laser apparatuses oscillate. When both laser apparatuses have oscillated (Step S5; YES), the processing may proceed to Step S6.

Then, the controller 54 may receive the measured third delay time δT from the delay time measuring unit 65 (Step S6). The controller 54 may then calculate a difference ΔT between the third delay time δT and the target value δTt through the following expression (Step S7).

ΔT=δT−δTt

Subsequently, the controller 54 may update the delay parameter α by adding the difference ΔT between the third delay time δT and the target value δTt to the delay parameter α (Step S8). That is, when the third delay time δT is greater than the target value δTt (ΔT>0), the delay parameter α may be increased by ΔT so that the second delay time ΔTo becomes smaller.

Thereafter, the controller 54 may determine whether or not the feedback control on the delay circuit 53 is to be stopped (Step S9). For example, when the output of the pulse laser beam is to be stopped based on a control signal from the EUV controller 51, the feedback control on the delay circuit 53 may be stopped. Alternatively, when the output energy of the EUV light reaches or exceeds a predetermined value as a result of repeating Steps S2 through S8 multiple times, the feedback control on the delay circuit 53 may be stopped and the second delay time δTo may be fixed to generate the EUV light. When the feedback control on the delay circuit 53 is not to be stopped (Step S9; NO), the processing may return to Step S2, and the controller 54 may receive the target value δTt of the third delay time and carry out the feedback control on the delay circuit 53. When the feedback control on the delay circuit 53 is to be stopped (Step S9; YES), the processing in this flowchart may be terminated.

As described above, by carrying out the feedback control on the delay circuit 53 based on the measured third delay time δT, the third delay time δT may be stabilized with high precision. As a result, the diffused target may be irradiated with the main pulse laser beam at an optimal third delay time, and a CE may be improved. Further, even in a case where the third delay time δT varies for some reason although the second delay time δTo is fixed, the feedback control may allow the third delay time δT to be stabilized.

In the second embodiment, the feedback control may be carried out on the delay circuit based on the measured third delay time. However, this disclosure is not limited thereto, and the third delay time may not be measured. For example, the second delay time δTo may be calculated from the initial value of the aforementioned delay parameter α and the aforementioned target value δTt, and the delay circuit 53 may be controlled based on this second delay time δTo.

The descriptions above are intended to be illustrative only and the present disclosure is not limited thereto. Therefore, it will be apparent to those skilled in the art that it is possible to make modifications to the embodiments of the present disclosure within the scope of the appended claims.

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

1. An extreme ultraviolet light generation system configured to irradiate a target with a first pulse laser beam and a second pulse laser beam to turn the target into plasma thereby generating extreme ultraviolet light, comprising:
a chamber having at least one aperture configured to introduce the first pulse laser beam and the second pulse laser beam;
a target supply device configured to supply the target to a predetermined region in the chamber;
a first laser apparatus configured to output the first pulse laser beam with which the target in the chamber is to be irradiated, the first pulse laser beam having pulse duration less than 1 ns; and
a second laser apparatus configured to output the second pulse laser beam with which the target which has been irradiated with the first pulse laser beam is to be further irradiated.

2. An extreme ultraviolet light generation system configured to irradiate a target with a first pulse laser beam and a second pulse laser beam to turn the target into plasma thereby generating extreme ultraviolet light, comprising:
a chamber having at least one aperture configured to introduce the first pulse laser beam and the second pulse laser beam;
a target supply device configured to supply the target to a predetermined region in the chamber;
a first laser apparatus configured to output the first pulse laser beam with which the target in the chamber is to be irradiated, the first pulse laser beam having pulse duration less than 500 ps; and
a second laser apparatus configured to output the second pulse laser beam with which the target which has been irradiated with the first pulse laser beam is to be further irradiated.

3. An extreme ultraviolet light generation system configured to irradiate a target with a first pulse laser beam and a second pulse laser beam to turn the target into plasma thereby generating extreme ultraviolet light, comprising:
a chamber having at least one aperture configured to introduce the first pulse laser beam and the second pulse laser beam;
a target supply device configured to supply the target to a predetermined region in the chamber;
a first laser apparatus configured to output the first pulse laser beam with which the target in the chamber is to be irradiated, the first pulse laser beam having pulse duration less than 50 ps; and
a second laser apparatus configured to output the second pulse laser beam with which the target which has been irradiated with the first pulse laser beam is to be further irradiated.

4. The extreme ultraviolet light generation system according to claim 1, wherein the first laser apparatus is configured to output the first pulse laser beam having fluence less than fluence of the second pulse laser beam and no less than 6.5 J/cm².

5. The extreme ultraviolet light generation system according to claim 1, wherein the first laser apparatus is configured to output the first pulse laser beam having fluence less than fluence of the second pulse laser beam and no less than 30 J/cm².

6. The extreme ultraviolet light generation system according to claim 1, wherein the first laser apparatus is configured to output the first pulse laser beam having fluence less than fluence of the second pulse laser beam and no less than 45 J/cm².

7. The extreme ultraviolet light generation system according to claim 2, wherein the first laser apparatus is configured to output the first pulse laser beam having fluence less than fluence of the second pulse laser beam and no less than 6.5 J/cm².

8. The extreme ultraviolet light generation system according to claim 3, wherein the first laser apparatus is configured to output the first pulse laser beam having fluence less than fluence of the second pulse laser beam and no less than 6.5 J/cm².

9. The extreme ultraviolet light generation system according to claim 2, wherein the first laser apparatus is configured to output the first pulse laser beam having fluence less than fluence of the second pulse laser beam and no less than 30 J/cm².

10. The extreme ultraviolet light generation system according to claim 3, wherein the first laser apparatus is configured to output the first pulse laser beam having fluence less than fluence of the second pulse laser beam and no less than 30 J/cm².

11. The extreme ultraviolet light generation system according to claim 2, wherein the first laser apparatus is configured to output the first pulse laser beam having fluence less than fluence of the second pulse laser beam and no less than 45 J/cm².

12. The extreme ultraviolet light generation system according to claim 3, wherein the first laser apparatus is configured to output the first pulse laser beam having fluence less than fluence of the second pulse laser beam and no less than 45 J/cm².
